(19) United States
(12) Patent Application Publication
(10) Pub. No.: US 2004/0246221 A1
(43) Pub. Date: Dec. 9, 2004

(54) Method of driving liquid crystal display element, method of determining drive conditions of liquid crystal display element and liquid crystal display apparatus

(75) Inventor: Tomoo Izumi, Toyonaka-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA HOLDINGS, INC.

(21) Appl. No.: 10/701,006

(22) Filed: Nov. 4, 2003

(30) Foreign Application Priority Data
May 23, 2003 (JP) 2003-145809

(51) Int. Cl. G09G 3/36

(52) U.S. Cl. 345/94

(57) ABSTRACT

Liquid crystal is supplied with a voltage pulse group including a reset period, a selection period and a retention period for drawing an image, and a time Ts (ms) from end of the reset period to start of the retention period and a time Tlc (ms) required for transition of the liquid crystal from a homeotropic state to a spiral structure state provide a ratio of Ts/Tlc satisfying a relationship (1) of (0.4≦Ts/Tlc≦1.0) when drawing the image. Thereby, contrast and a gamma curve can be appropriately provided to perform good display.

### CROSS-REFERENCE TO RELATED APPLICATION

This application is based on Japanese patent application No. 2003-145809 filed in Japan on May 23, 2003, the entire content of which is hereby incorporated by reference.

### BACKGROUND OF THE INVENTION

1. Field of the Invention

The present invention relates to a method of driving a liquid crystal display element as well as a liquid crystal display apparatus, and also relates to a method of determining drive conditions of a liquid crystal display element.

2. Description of Related Art

In recent years, various liquid crystal display elements of a reflective type using liquid crystal (typically, chiral nematic liquid crystal), which exhibits a cholesteric phase at a room temperature, have been studied and developed because such liquid crystal display elements have a memory property for maintaining display even when a voltage is not applied, and thereby require a low power consumption and a low manufacturing cost.

For fast driving of such liquid crystal display elements, a three-stage driving method has been proposed. In this method, liquid crystal contained in the element is supplied with a driving voltage having a waveform, which includes a reset period for resetting the liquid crystal to a homeotropic state, a selection period for determining an intended final state of the liquid crystal and a retention period for retaining the selected state of the liquid crystal, and thus is supplied with a voltage pulse group including such periods.

For example, U.S. Pat. Nos. 5,748,277 and 6,154,190 as well as Japanese National Publication No. 2000-514932 of translation of international patent application (Tokuhyou 2000-514932) have disclosed a driving method, in which a preparation voltage, a selection voltage and an evolution voltage are successively applied to liquid crystal for displaying images. Further, U.S. Pat. No. 6,154,190 has disclosed provision of a post-preparation phase and an after-selection phase before and after the application of the selection voltage, respectively.

The above three-stage driving method utilizes transition of the liquid crystal from a homeotropic state to a spiral structure state, and a period (Tlc) required for such state transition of the liquid crystal is significantly affected by physical properties of the liquid crystal. The pulse determining the final state of the liquid crystal is applied in accordance with predetermined timing during a period of time (Ts) from end of the reset period to start of the retention period, and typically in a midrange of the period of time (Ts)

Accordingly, it is necessary to set an appropriate value of the time (Ts) with respect to the period (Tlc). Otherwise, the pulse determining the final state of the liquid crystal cannot be applied by utilizing the transition of the liquid crystal from the homeotropic state to the spiral structure state in accordance with appropriate timing. If such application is impossible, contrast in display may lower, and/or a relationship between a voltage value of the pulse and a peak reflectance of the liquid crystal display element, which is finally achieved, cannot exhibit an appropriate curve so that good display is impossible.

The curve representing the relationship between the voltage value of the pulse determining the final state of the liquid crystal and the peak reflectance of the liquid crystal display element, which is finally achieved, is referred to as a “gamma curve” by the inventors and others, and is represented on coordinates, in which an abscissa gives the voltage value of the pulse and an ordinate gives the reflectance of the liquid crystal display element at the peak selective reflection wavelength, as will be described later with reference to FIG. 20.

According to the study by the inventors, if the gamma curve is relatively gentle or flat, the applied voltage, which does not extend over an excessive range, cannot set the liquid crystal sufficiently to a planar state (sufficient reflection state of the display element) and a sufficient focal conic state (sufficient transparent state of the display element) without difficulty so that it is difficult to achieve good contrast. If the gamma curve is excessively steep, it is difficult to deal with variations in environment (primarily, variations in environment temperature) and changes of the liquid crystal display element with time so that good display is difficult. The gamma curve must be appropriately determined to suppress such problems.

### SUMMARY OF THE INVENTION

Accordingly, an object of the invention is to provide a method of driving a liquid crystal display element having a memory property and performing display by utilizing selective reflection of a cholesteric liquid crystal phase, and particularly to provide a liquid crystal display element driving method, which can perform good display by providing appropriate contrast and an appropriate gamma curve.

Another object of the invention is to provide a liquid crystal display apparatus having a liquid crystal display element, which has a memory property and performs display by utilizing selective reflection of a cholesteric liquid crystal phase, and particularly to provide a liquid crystal display apparatus, which has a liquid crystal display element providing appropriate contrast and an appropriate gamma curve, and can perform good display.

Still another object of the invention is to provide a method of determining conditions for driving a liquid crystal display element, which has a memory property and performs display by utilizing selective reflection of a cholesteric liquid crystal phase, for performing good display by the liquid crystal display element.

For achieving the above objects, the inventors have made studies to find the followings. In the case of driving a liquid crystal display element, which has a memory property and performs display by utilizing selective reflection of a cholesteric liquid crystal phase, by the foregoing three-stage driving method, appropriate contrast and an appropriate gamma curve can be achieved to perform good display when such condition is satisfied that a ratio of Ts/Tlc satisfies a relationship of 0.4≦Ts/Tlc≦1.0, where Ts (ms: millisecond(s)) represents a time from end of a reset period to start of a retention period, and Tlc (ms: millisecond(s)) represents a period required for transition of liquid crystal from the homeotropic state to the spiral structure state.

Based on the above finding, the invention provides a method of driving a liquid crystal display element, and a liquid crystal display apparatus, which will be described below. The invention also provides a method of determining drive conditions of a liquid crystal display element, which will also be described below.

[1] Method of Driving a Liquid Crystal Display Element

A method of driving a liquid crystal display element having a memory property and performing display by utilizing selective reflection of a cholesteric liquid crystal phase, wherein

a driving voltage (voltage pulse group) of a waveform including a reset period for resetting liquid crystal included in the liquid crystal display element to a homeotropic state, a selection period for selecting liquid crystal arrangement (arrangement of liquid crystal molecules) in a voltage-free state and a retention period for ensuring a final display state of the liquid crystal is applied to the liquid crystal for drawing an image, and a time Ts (ms) from end of the reset period to start of the retention period and a period Tlc (ms) required for transition of the liquid crystal from the homeotropic state to a spiral structure state provide a ratio of Ts/Tlc satisfying a relationship (1) of (0.4≦Ts/Tlc≦1.0) when drawing the image.

[2] Liquid Crystal Display Apparatus

A liquid crystal display apparatus including a liquid crystal display element having a memory property and performing display by utilizing selective reflection of a cholesteric liquid crystal phase, and a driving circuit for the liquid crystal display element, wherein

a driving voltage (voltage pulse group) of a waveform including a reset period for resetting liquid crystal included in the liquid crystal display element to a homeotropic state, a selection period for selecting liquid crystal arrangement (arrangement of liquid crystal molecules) in a voltage-free state and a retention period for ensuring a final display state of the liquid crystal is applied by the driving circuit to the liquid crystal for drawing an image, and a time Ts (ms) from end of the reset period to start of the retention period and a period Tlc (ms) required for transition of the liquid crystal from the homeotropic state to a spiral structure state provide a ratio of Ts/Tlc satisfying a relationship (1) of (0.4≦Ts/Tlc≦1.0) when drawing the image.

[3] Method of Determining Drive Conditions of a Liquid Crystal Display Element

A method of determining drive conditions of a liquid crystal display element having a memory property, performing display by utilizing selective reflection of a cholesteric liquid crystal phase, and drawing an image by being supplied with a driving voltage (voltage pulse group) of a waveform including a reset period for resetting liquid crystal included in the liquid crystal display element to a homeotropic state, a selection period for selecting liquid crystal arrangement (arrangement of liquid crystal molecules) in a voltage-free state and a retention period for ensuring a final display state of the liquid crystal, the method including the steps of:

measuring a period Tlc (ms) required for transition of the liquid crystal from the homeotropic state to a spiral structure state; and

determining a time Ts (ms) from end of the reset period to start of the retention period to satisfy a relationship of (0.4≦Ts/Tlc≦1.0) with respect to the measured period Tlc.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a sectional view schematically showing a structure of a reflective type liquid crystal display element.

FIG. 2 is a block diagram showing an example of a driving circuit which is a main part of a driving device which applies driving voltages to the liquid crystal display layer.

FIG. 3 shows an example of a detailed structure of the driving circuit shown in FIG. 2.

FIG. 4(A) shows a basic driving waveform which is output from a scanning driving IC to each scanning electrode in odd-numbered frames, and FIG. 4(B) shows a basic driving waveform which is output from the scanning driving IC to each scanning electrode in even-numbered frames.

FIG. 5 shows waveforms of voltages which are output from the scanning driving IC to the scanning electrodes, a waveform of voltage which is output from a signal driving IC to one of signal electrodes, and waveforms of voltages which are applied to liquid crystals corresponding to pixels, in one of the odd-numbered frames.

FIG. 6 shows waveforms of voltages which are output from the scanning driving IC to the scanning electrodes, a waveform of voltage which is output from the signal driving IC to one of the signal electrode, and waveforms of voltages which are applied to the liquid crystals corresponding to pixels, in one of the even-numbered frames.

FIG. 7 shows another example of the driving circuit, and shows a state in an odd-numbered frame (plus frame) in which switching elements are changed over to a side 1.

FIG. 8 shows a state in an even-numbered frame (minus frame) in the circuit shown in FIG. 7, in which the switching elements are changed over to a side 2.

FIG. 9 shows a waveform of a selection pulse which is output to one of the row electrodes(scanning electrodes), a waveform of a signal pulse which is output to one of the column electrodes (signal electrodes) and a voltage waveform applied to the liquid crystal by these pulse voltages for finally selecting a selective reflection state of the liquid crystal, in one of the odd-numbered frames.

FIG. 10 shows a waveform of a selection pulse which is output to one of the row electrodes, a waveform of a signal pulse which is output to one of the column electrodes and a waveform which is applied to the liquid crystal by these pulse voltages for finally selecting a transparent state of the liquid crystal, in one of the odd-numbered frames.

FIG. 11 shows a waveform of a selection pulse which is output to one of the row electrodes, a waveform of a signal pulse which is output to one of the column electrodes and a voltage waveform which is applied to the liquid crystal by these pulse voltages for finally selecting an intermediate tone display state of the liquid crystal in, in one of the odd-numbered frames.

FIG. 12 shows a basic driving waveform which is output to each of the scanning electrodes in another example of driving of the liquid crystal display element.

FIG. 13 shows waveforms of voltages which are output to the scanning electrodes, a waveform of a signal pulse which is output to one of the signal electrodes and waveforms of voltages applied to the liquid crystals corresponding to pixels by these pulse voltages, when the basic driving waveform shown in FIG. 12 is employed.

FIGS. 14(A), 14(B) and 14(C) illustrate waveforms of voltages applied to attain planar and other states of liquid crystal of pixels when the basic driving waveform illustrated in FIG. 12 is employed. FIG. 14(A) illustrates a voltage waveform attaining a planar state of liquid crystal LCDx of a pixel, FIG. 14(B) illustrates a selection voltage waveform attaining a focal conic state of the liquid crystal LCDx, and FIG. 14(C) illustrates an example of a selection voltage waveform attaining halftone display by the liquid crystal LCDx.

FIG. 15 illustrates relationships between the wavelength and the reflectance in the planar state and focal conic state of liquid crystal having a peak selective reflection wavelength of 600 nm.

FIG. 16 illustrates relationships between the wavelength and the reflectance in the planar state and focal conic state of liquid crystal having a peak selective reflection wavelength of 540 nm.

FIG. 17 illustrates a manner of determining a period Tlc required for transition of liquid crystal from a homeotropic state to a spiral structure state.

FIGS. 18(A) and 18(B) illustrate gamma curve groups relating to the liquid crystal in FIG. 15. FIG. 18(A) illustrates gamma curves having relatively gentle forms, and FIG. 18(B) illustrates gamma curves having relatively steep forms.

FIGS. 19(A) and 19(B) illustrate gamma curve groups relating to the liquid crystal in FIG. 16. FIG. 19(A) illustrates gamma curves having relatively gentle forms, and FIG. 19(B) illustrates gamma curves having relatively steep forms.

FIG. 20 illustrates by way of example a gamma curve and a gamma value.

### DESCRIPTION OF THE PREFERRED EMBODIMENTS

(Method of Driving a Liquid Crystal Display Element)

The method is a method of driving a liquid crystal display element having a memory property and performing display by utilizing selective reflection of a cholesteric liquid crystal phase.

This liquid crystal display element is supplied with a driving voltage (voltage pulse group) of a waveform, which basically includes a reset period for resetting liquid crystal included in the liquid crystal display element to a homeotropic state, a selection period for selecting liquid crystal arrangement in a voltage-free state and a retention period for ensuring a final display state of the liquid crystal, and thereby draws an image (i.e., displays an image).

In the above image display, a time Ts (ms) from end of the reset period to start of the retention period and a period Tlc (ms) required for transition of the liquid crystal from the homeotropic state to a spiral structure state provide a ratio of Ts/Tlc satisfying a relationship (1) of (0.4≦Ts/Tlc≦1.0) when drawing the image.

The above ratio of Ts/Tlc, which satisfies the relationship (1) of (0.4≦Ts/Tlc≦1.0), can provide appropriate contrast and an appropriate gamma curve in the display by the liquid crystal display element, and thereby can achieve good image display with good contrast while suppressing influences by environmental variations (primarily, variations in environment temperature) and changes of the element with time.

It is more preferable that the ratio of Ts/Tlc satisfies the relationship (2) of (0.5≦Ts/Tlc≦0.9) By satisfying this relationship (2), the liquid crystal display element can achieve the appropriate contrast and the appropriate gamma curve more reliably.

For driving the liquid crystal display element, a pulse voltage setting the liquid crystal to the planar state may be applied during the selection period so that the liquid crystal carrying the voltage attains the selective reflection state. When a pulse voltage setting the liquid crystal to the focal conic state is applied, the liquid crystal carrying the voltage attains a transparent state. Further, during the above selection period, at least one of a width and a voltage value of the pulse applied to the liquid crystal may be modulated so that halftone display intermediate between the selective reflection state and the transparent state can be achieved.

The time Tlc required for the transition from the homeotropic state to the spiral structure state changes depending on a temperature of the liquid crystal. Accordingly, the method may be configured to change the time Ts according to the temperature of the liquid crystal display element or a neighboring portion, and thereby to provide the ratio of Ts/Tlc satisfying the relationship (1).

For reducing power consumption, the polarity of the voltage applied to the liquid crystal may be inverted in every frame. An AC voltage may be employed as the voltage applied to the liquid crystal. This can advantageously suppress deterioration of the liquid crystal.

(Liquid Crystal Display Apparatus)

The liquid crystal display apparatus includes a liquid crystal display element having a memory property and performing display by utilizing selective reflection of a cholesteric liquid crystal phase, and a driving circuit for driving the liquid crystal display element.

This liquid crystal display element is supplied by the driving circuit with a driving voltage (voltage pulse group) of a waveform, which basically includes a reset period for resetting liquid crystal included in the liquid crystal display element to a homeotropic state, a selection period for selecting liquid crystal arrangement in a voltage-free state and a retention period for ensuring a final display state of the liquid crystal, and thereby draws an image (displays an image).

The above driving circuit satisfies a relationship of (0.4≦Ts/Tlc≦1.0), where Ts represents a period (ms) from end of the reset period to start of the retention period, and a Tlc represents a period required for transition of the liquid crystal from the homeotropic state to a spiral structure state.

The liquid crystal display apparatus likewise satisfies the relationship (1) of (0.4≦Ts/Tlc≦1.0) so that it can provide appropriate contrast and an appropriate gamma curve in the display by the liquid crystal display element, and thereby can achieve good image display with good contrast as a whole of the apparatus while suppressing influences by environmental variations (primarily, variations in environment temperature) and changes of the element with time.

Likewise, in this liquid crystal display apparatus, it is more preferable that the ratio of Ts/Tlc satisfies the relationship (2) of (0.5≦Ts/Tlc≦0.9). By satisfying this relationship (2), the liquid crystal display element can achieve the appropriate contrast and the appropriate gamma curve more reliably so that the liquid crystal display apparatus can perform good image display more reliably.

Likewise, in this liquid crystal display apparatus, the driving circuit can set the liquid crystal to the planar state (selective reflection state) or the focal conic state (transparent state). The driving circuit may be configured to modulate at least one of a width and a voltage value of the pulse applied to the liquid crystal during the selection period so that the halftone display can be achieved.

This liquid crystal display apparatus may be provided with a temperature detector for dealing with variations in physical properties of the liquid crystal due to changes in temperature, and the driving circuit may be configured to change the time Ts with respect to the period Tlc at a detected temperature to satisfy the foregoing relationship (1) based on temperature information provided from the temperature detector.

For reducing the power consumption, the driving circuit may be configured such that the polarity of the voltage applied to the liquid crystal is inverted in every frame. The driving circuit may employ an AC voltage as the voltage applied to the liquid crystal. This can advantageously suppress deterioration of the liquid crystal.

(Method of Determining Drive Conditions of a Liquid Crystal Display Element)

The method is a method of determining drive conditions for driving a liquid crystal display element, which has a memory property, performs display by utilizing selective reflection of a cholesteric liquid crystal phase, and drawing an image by being supplied with a driving voltage (voltage pulse group) of a waveform including a reset period for resetting liquid crystal included in the liquid crystal display element to a homeotropic state, a selection period for selecting liquid crystal arrangement (arrangement of liquid crystal molecules) in a voltage-free state and a retention period for ensuring a final display state of the liquid crystal.

The drive condition determining method basically includes the steps of:

measuring a period Tlc (ms) required for transition of the liquid crystal from the homeotropic state to a spiral structure state; and

determining a time Ts (ms) from end of the reset period to start of the retention period to satisfy a relationship of (0.4≦Ts/Tlc≦1.0) with respect to the measured period Tlc.

The above period Tlc may be determined, for example, as follows.

The determination may be performed by executing:

a data obtaining step of repeating a step of applying a reset pulse enough to reset the liquid crystal to the homeotropic state and applying a retention pulse after elapsing of a time Tint (ms) from end of the application of the reset pulse, and a step of measuring a reflectance of the liquid crystal display element at a peak selective reflection wavelength after end of the application of the retention pulse, while changing the value of the time Tint (ms) and changing the retention pulse with respect to each of the values of the time Tint (ms),

a characteristic curve producing step of producing characteristic curves representing variations in reflectance of the liquid crystal display element at the peak selective reflection wavelength corresponding to voltage values of the retention pulse with respect to each of the values of the time Tint (ms) obtained in the data obtaining step, and

a step of determining, as a value of the period Tlc (ms), the smallest time value of the time Tint (ms) among the values substantially causing matching between the plurality of characteristic curves in the characteristic curve group obtained in the characteristic curve producing step.

The retention pulse applied in the data obtaining step may have a voltage value large enough to establish a selected state based on a selection pulse applied for selecting the intended final state of the liquid crystal during the selection period.

In the liquid crystal display element driving method, the liquid crystal display apparatus and the driving condition determining method described above, the liquid crystal display element may include a plurality of scanning electrodes and a plurality of signal electrodes opposed to the scanning electrodes with a layer of the liquid crystal therebetween for applying a pulse voltage to the liquid crystal. In this case, a simple matrix driving method may be employed for driving the liquid crystal display element.

In a typical example of the simple matrix driving method of the liquid crystal display element, the plurality of scanning electrodes and the plurality of signal electrodes are supplied with the liquid crystal driving voltage for the simple matrix driving in such a manner that the respective scanning electrodes are successively set to a selected state by successively applying a selection signal voltage to the respective scanning electrodes with a predetermined time difference, a rewriting signal voltage is applied to each of the plurality of signal electrodes, and the application of the rewriting signal voltage is performed by applying, with respect to each of the scanning electrodes set to the selected state, a signal voltage corresponding to the scanning electrode in synchronization with the application of the selection signal voltage to the scanning electrode. In the liquid crystal display apparatus, the driving circuit is configured to perform the simple matrix driving in the above manner.

In the case, where the above simple matrix driving method is employed, the selection signal voltage applied to the scanning electrode may have a waveform including the reset period for applying the reset pulse for resetting the liquid crystal in the liquid crystal display element to the homeotropic state, the selection period for applying the selection pulse for selecting the arrangement of the liquid crystal molecules in the voltage-free state, and the retention period for applying the retention pulse for establishing the final display state of the liquid crystal. The rewriting signal voltage may be, e.g., a pulse voltage having an alternating waveform.

For the above simple matrix driving, the selection signal voltage and the rewriting signal voltage provides a voltage pulse group including a reset period for applying a reset pulse for resetting the liquid crystal in the liquid crystal display element to the homeotropic state, a selection period for applying a selection pulse for selecting the arrangement of the liquid crystal molecules in the voltage-free state, and a retention period for applying a retention pulse for establishing a final display state of the liquid crystal.

In any case, it is desirable that the pulse voltage applied to the signal electrode has an absolute value smaller than a threshold causing so-called cross-talk.

The liquid crystal included in the liquid crystal display element is merely required to exhibit a cholesteric phase at a room temperature so that the display can be performed by utilizing the selective reflection performance of the liquid crystal, and particularly, it is suitable to use chiral nematic liquid crystal prepared by adding a chiral material, which is enough in amount to exhibit a cholesteric liquid crystal phase, to a nematic liquid crystal. The chiral nematic liquid crystal is suitable because it exhibits a memory property, which allows retention of the selected display state even when a voltage is not applied.

In any one of the above structures and methods, the liquid crystal display element may be of either a monochrome display type or a full-color display type.

Embodiments of the present invention will be described with reference to the accompanying drawings.

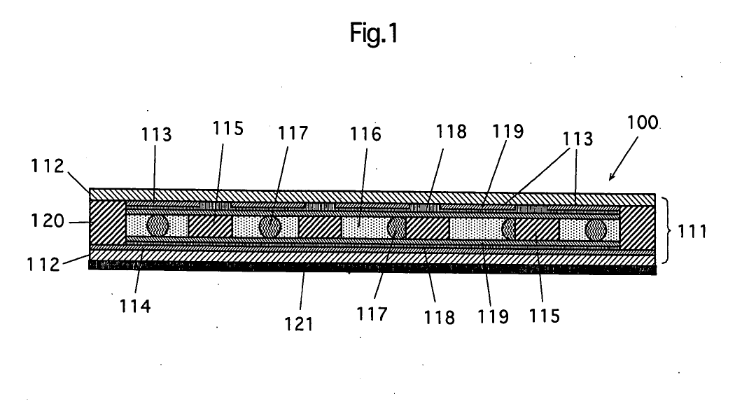

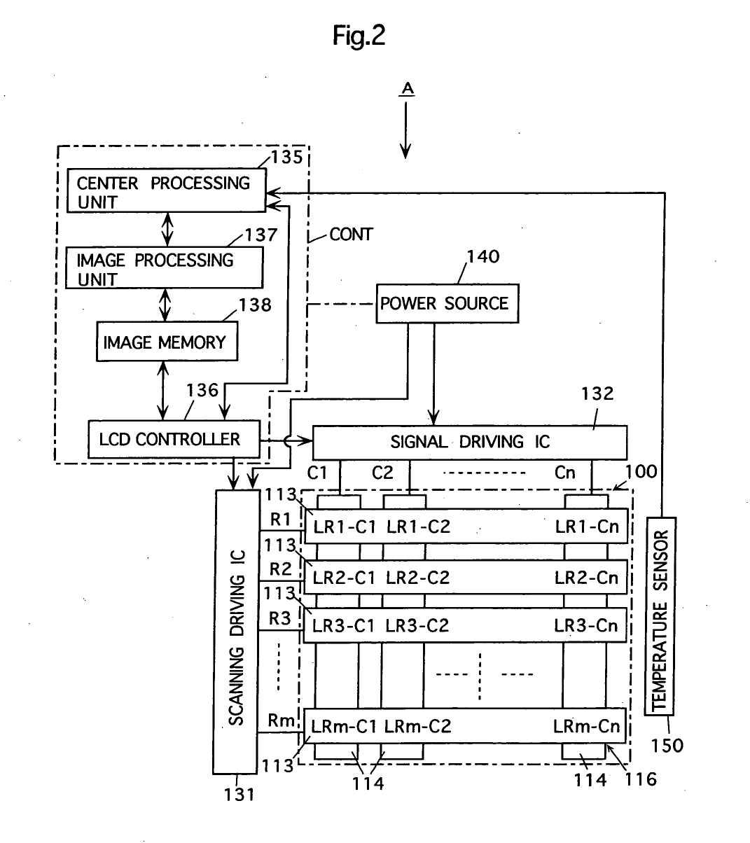

(Liquid Crystal Display Element, See FIG. 1 and FIG. 2)

First, a liquid crystal display element which is a part of an example of the liquid crystal display apparatus shown in FIG. 2 will be described.

FIG. 1 is a sectional view schematically showing a structure of a reflective/single layer type liquid crystal display element which can be driven by simple matrix driving method.

The liquid crystal display element 100 shown in FIG. 1 comprises a light absorbing layer 121 and a liquid crystal display layer 111 which is capable of performing display by switching a selective reflective state to a transparent state and vice versa.

The display layer 111 comprises a transparent substrate 112 which has transparent electrodes 113 on its inner surface and is disposed on a image observation side, and another transparent substrate 112 which has transparent electrodes 114 on its inner surface and is disposed on a side remote from the image observation side.

The display layer 111 further includes resin column structures 115, a liquid crystal 116 and spacers 117 between the pair of substrates 112. The light absorbing layer 121 is formed on an outer surface of the substrate 112 on the side remote from the image observation side.

The resin column structures 115 connect the substrates 112. The spacers 117 maintain a predetermined gap between the substrates 112 and determines a thickness of the liquid crystal 116. The column structures are also helpful in maintaining the gap.

Insulating film 118 and/or orientation-controlling film 119 may be formed on the electrodes 113 and/or the electrodes 114, when so required. In this example shown in FIG. 1, those films 118,119 are formed on the electrodes 113,114. A seal material 120 is provided to seal the liquid crystal 116 at a periphery of the space between the substrates 112 (outside the display region).

In this example, the electrodes 113 are scanning electrodes, and the electrodes 114 are signal electrodes. These transparent electrodes 113, 114 are connected to a scanning driving IC 131 and a signal driving IC 132 (see FIG. 2) to be described later, respectively, and a predetermined pulse voltage is applied to the electrodes 113, 114, respectively.

In response to the applied pulse voltages, the display of the liquid crystal 116 is switched between a transparent state (focal conic state) which passes visible light therethrough and a selective reflective state (planar state) which selectively reflects visible light of specific wavelengths. An intermediate tone display in which the transparent state and the selective reflective state are mixed can be also obtained according to a voltage applied to the liquid crystal.

The transparent electrodes 113 are a plurality of strip electrodes extending in parallel with each other with a minute space away from each other. The transparent electrodes 114 are also a plurality of strip electrodes extending in parallel with each other with a minute space away from each other.

The electrodes 113, 114 are opposed to each other in a direction orthogonal to each other when viewed on a plane. Voltages are successively applied to the upper and lower strip electrodes. Namely a voltage is successively applied to the liquid crystal 116 in a matrix manner to display an image. This method is called matrix driving. Each pixel corresponds to a portion at which the electrode 113 and the electrode 114 cross each other when viewed on a plane. Such matrix driving is conducted on the display layer 111, whereby a monochromatic (mono-color) image formed by a color observed in the selective reflective state of the liquid crystal 116 and a black color due to the light absorbing layer 121 can be displayed in the liquid crystal display element 100.

A liquid crystal exhibiting a cholesteric phase (cholesteric characteristic) at room temperature can be preferably used as the liquid crystal 116. Especially it is suitable to use a chiral nematic liquid crystal prepared by adding a chiral material to a nematic liquid crystal in an amount sufficient to show a cholesteric phase.

The chiral material is an additive which is capable of twisting the molecules of nematic liquid crystal when added to the nematic liquid crystal. The nematic liquid crystal is imparted a helical structure of twisted molecules of liquid crystal by addition of the chiral material to the nematic liquid crystal, whereby it is caused to show a cholesteric phase.

The structure of liquid crystal display layer 111 is not necessarily limited to the above. A resin structure in the form of a wall or the like may be used instead of the column structure 115, or such resin structure may be omitted. Useful structures of the liquid crystal layer include conventional structures such as a layer structure wherein a liquid crystal is dispersed in a three-dimensional polymer network, a layer structure wherein a three-dimensional polymer network is formed in a liquid crystal (so-called polymer-dispersed type liquid crystal composite film) and the like.

The light absorbing layer 121 exhibits black when the liquid crystal is transparent. However, the light absorbing layer 121 may be replaced with another layer exhibiting another color. For example, a blue display layer may be combined with a liquid crystal display layer using liquid crystal, which performs selective reflection in yellow. In this case, mono-color display in blue and whitish colors can be performed. For example, a light absorbing layer or a blue display layer may be combined with a liquid crystal layer using liquid crystal, in which the selective reflection peak is present in a wide wavelength range. This allows monochrome display in white and block or in white and blue.

The substrate 112 may be a glass substrate, a resin film made of, e.g., polycarbonate or the like. Both the substrates 112 are transparent. However, at least one of the substrates may not be transparent provided that the other (particularly, the substrate on the image observation side or viewer side) is transparent. If the substrate, which may not be transparent, performs display in black or predetermined another color, the layer such as the light absorbing layer 121 on the outer surface of the substrate may be eliminated.

The insulating film 118 may be made of an inorganic material such as silicone oxide, or an organic material such as polyimide resin. Dye(s) may be added to the insulating film 118.

The orientation-controlling film 119 may be made of an organic material such as polyimide resin, or an inorganic material such as aluminum oxide. Rubbing may be effected on the orientation-controlling film 119, if necessary. Each of the insulating film and the orientation-controlling film may serves also as the other.

The transparent electrodes 113 and 114 may be formed of electrically conductive and transparent films made of, e.g., ITO (Indium Tin Oxide).

Although the liquid crystal display apparatus A includes only one liquid crystal layer 111, the liquid crystal display apparatus may include two or more liquid crystal layers. For example, a display layer for selective reflection in blue and a display layer for selective reflection in yellow may be overlaid on each other to provide a layered-type monochrome display apparatus, in which these display layers can be driven simultaneously to perform the display in black and white. Also, a display layer for selective reflection in blue, a display layer for selective reflection in green and a display layer for selective reflection in red may be overlaid on each other to provide a full-color display apparatus of a layered type, in which each of the display layers can be driven independently of the others. A display apparatus may employ four liquid crystal display layers overlaid on each other. This can be achieved by adding a display layer for selective reflection in yellow to the foregoing three-layer full-color display apparatus.

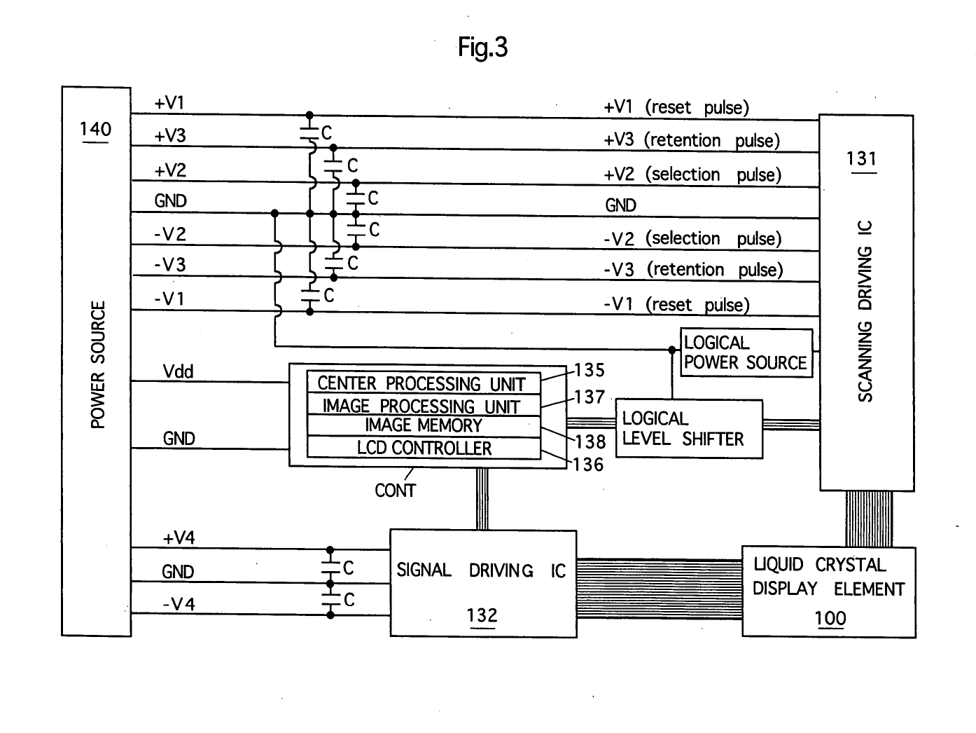

(Driving Circuit, See FIGS. 2 and 3)

FIG. 2 is a block diagram showing an example of a driving circuit for applying driving voltages to the liquid crystal display layer 111 of the liquid crystal display element 100. FIG. 3 shows an example of a detailed structure of the driving circuit shown in FIG. 2. A logical power source and a logical level shifter shown in FIG. 3 are omitted in FIG. 2. The liquid crystal display apparatus A comprises the liquid crystal display element 100 and the driving circuit shown in FIGS. 2 and 3.

The driving circuit shown in FIGS. 2 and 3 include the scanning driving IC (driver) 131, the signal driving IC (driver) 132, a controller CONT and a power source 140.

The controller CONT is provided with a central processing unit (CPU) 135 adapted to control the driving circuit in its entirety, a LCD controller 136 adapted to control the driving ICs, an image processing unit 137 for processing image data in various manners, and an image memory 138 for storing image data. A power is supplied to the controller CONT from the power source 140. The CPU 135 includes a ROM in which a controlling program and various data are stored and a RAM in which various data are stored. The driving ICs 131, 132 are also connected to the power source 140

The controller CONT is connected to the signal driving IC 132 and, via a logical level shifter, to the scanning driving IC 131. The logical level shifter is a circuit adapted to shift a ground(GND) potential to 0V for compensation if the ground(GND) potential is changed from 0V despite the ground (GND) to be kept at 0V corresponding to voltages to be supplied to the scanning driving IC. The LCD controller 136 drives each driving IC according to the image data stored in the memory 138 based on directions from the CPU 135.

The liquid crystal display apparatus is provided with a temperature sensor 150, which measures an environment temperature near the liquid crystal display element, and provides environment temperature information to the central processing unit 135.

According to the illustrated liquid crystal display apparatus A, the driving ICs 131, 132 are controlled by the LCD controller 136 based on image data stored in the image memory 138 included in the controller. Voltages are successively applied between the scanning electrodes and the signal electrodes in the liquid crystal display element 100, whereby an image is written in the liquid crystal display element 100.

In the liquid crystal display element 100 shown in FIG. 2, the driving ICs 131, 132 are connected to the liquid crystal display layer 111. In case of a liquid crystal display apparatus having a plurality of liquid crystal display layers, driving ICs are preferably provided in each of the display layers (namely ICs are provided in the plural kinds of layers, respectively). It is possible to use any one of the scanning driving IC and the signal driving IC in common with these layers.

The pixel arrangement of the liquid crystal display element 100 is represented by a matrix comprising the plurality of scanning electrodes 113 (R1, R2 . . . Rm in FIG. 2) and the plurality of signal electrodes 114 (C1, C2 . . . Cn in FIG. 2) (“m” and “n” being a natural number) as shown in FIG. 2. The scanning electrodes R1, R2 . . . Rm are connected to output terminals of the scanning driving IC 131, and the signal electrodes C1, C2 . . . Cn are connected to output terminals of the signal driving IC 132.

The scanning driving IC 131 is connected to the scanning electrodes R1, R2 . . . Rm as described above, to the controller CONT and to the power source 140. The driving IC 131 applies a group of pulse voltages including a reset voltage (+V1 or −V1), a selection signal voltage (+V2 or −V2) and a retention voltage (+V3 or −V3)) to the scanning electrodes R1, R2 . . . Rm according to directions from the controller CONT.

Voltage stabilizing condensers C connected to the ground(GND) corresponding to said voltages are connected to connection lines for supplying the voltages +V1, +V2 and +V3, and −V1, −V2 and −V3 to the scanning electrodes 113. The logical power source connected to the scanning driving IC 131 is provided for supply of power to the scanning driving IC 131.

The signal driving IC 132 is connected, as described above, to the signal electrodes C1, C2 . . . Cn, to the controller CONT and to the power source 140. A voltage (rewriting signal voltage (+V4, −V4)) output from the power source 140 according to directions from the controller CONT is applied to the signal electrodes C1, C2 . . . Cn, respectively.

Voltage stabilizing condensers C connected to a ground(GND) corresponding to said voltages are connected to connection lines for supplying the driving voltage (+V4, −V4) to the signal electrodes.

More specifically stated, the scanning driving IC 131 outputs the selection-signal voltage to predetermined one among the scanning electrodes R1, R2 . . . Rm to bring it to a selective state while it outputs non-selection signals to other electrodes under directions from the controller CONT to bring them to a non-selective state. The scanning driving IC 131 successively applies the selection signal voltage to the scanning electrodes R1, R2 . . . Rm, while switching the electrodes with a predetermined time difference. The application of the selection signal voltage to one scanning electrode is performed in a scanning period set for the scanning electrode.

On the other hand, the signal driving IC 132 simultaneously outputs the signals (rewriting signal voltages) corresponding to the image data to the signal electrodes C1, C2 . . . Cn according to directions from the controller CONT to rewrite each pixel on the scanning electrode in the selective state.

For example, if a scanning electrode Ra is selected (“a” of the Ra is a natural number satisfying “a”≦m), pixels LRa-C1 . . . LRa-Cn corresponding to intersections between the scanning electrode Ra and the signal electrodes C1, C2 . . . Cn are rewritten at the same time. A voltage difference between the selection pulse voltage (selection signal voltage) applied to the scanning electrode and the signal pulse voltage (rewriting signal voltage) applied to the signal electrode in each pixel is a voltage for rewriting the pixel so that the pixel is rewritten according to the voltage.

The controller CONT is adapted to control the scanning driving IC 131 such that the driving voltage to be applied to the scanning electrodes R1, R2 . . . Rm in scanning operation in each frame for matrix driving of the liquid crystal display element 100 has a single polarity in each frame and the polarity of the driving voltage is reversed in every frame.

More specifically stated, when scanning is performed in odd-numbered frames, the scanning driving IC 131 successively applies a group of voltages (i.e., the positive reset pulse voltage +V1, the positive selection pulse voltage +V2 and the positive retention pulse voltage +V3) to each scanning electrode R1, R2 . . . Rm while the signal driving IC 132 applies the signal pulse +V4 to each signal electrode C1, C2 . . . Cn.

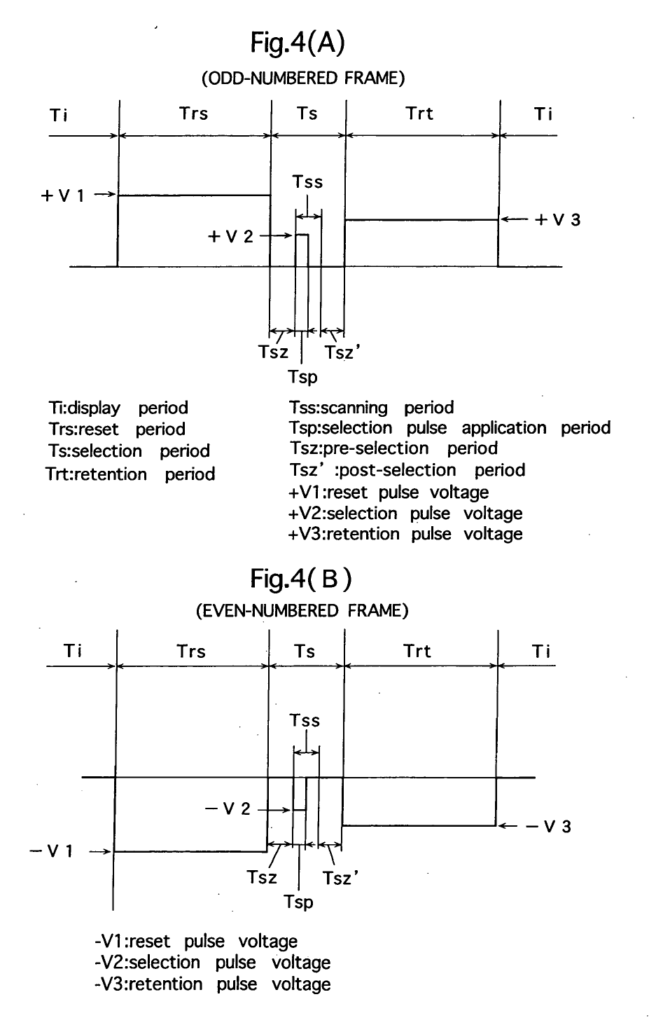

When scanning is performed in even-numbered frames, the scanning driving IC 131 successively applies a group of voltages (i.e., the negative reset pulse voltage −V1, the negative selection pulse voltage −V2 and the negative retention pulse voltage −V3) to each scanning electrode R1, R2 . . . Rm while the signal driving IC 132 applies the signal pulse+V4 to each signal electrode C1, C2 . . . Cn (see FIGS. 4 to 6).

In the foregoing operation, the application period Tsp of the selection pulse voltage (selection signal voltage) (+V2 or −V2) is ½ the scanning period Tss and the signal pulse +V4 is a voltage which is changed in polarity within the scanning period Tss and effective values of positive and negative voltages thereof are substantially equal to each other within the scanning period Tss.

Further the signal pulse is such that each of total of period(s) of the positive voltage and total of period(s) of the negative voltage within the scanning period Tss is as long as the application period Tsp of the selection pulse.

The controller CONT controls the scanning driving IC 131 such that the application period Tsp of the selection pulse (+V2 or −V2) is ½ the scanning period Tss and controls the signal driving IC 132 such that the signal pulse +V4 is a voltage which is changed in polarity within the scanning period Tss; the effective values of the positive and negative voltages of the signal pulse are substantially equal to each other within the scanning period Tss; and the signal pulse is such that each of total of period(s) of the positive voltage and total of period(s) of the negative voltage within the scanning period is as long as the application period of selection pulse (+V2, −V2). This matter will be described in more detail in respect of driving principle and example of basic driving.

The signal pulse voltage ±V4 is a rectangular pulse voltage which has a duty ratio of 50% and the absolute values of positive and negative voltages (+V4, −V4) are identical with each other.

In this driving circuit, the power source 140 can supply both positive and negative voltages at least all the time during driving operation. The driving voltage is applied to the scanning electrodes R1, R2 . . . Rm by the scanning driving IC connected to the power source 140.

However, the supply of power is not limited to the above. The driving voltage may be applied to the scanning electrodes R1, R2 . . . Rm by the scanning driving IC connected to a power source which can switch output voltages from positive to negative and vice versa.

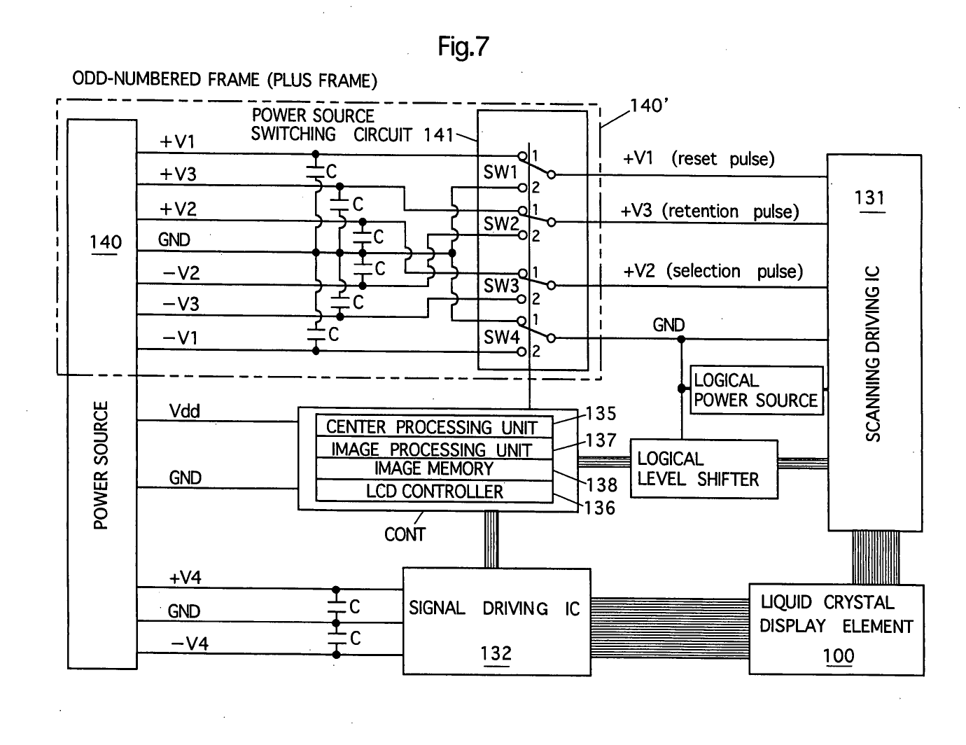

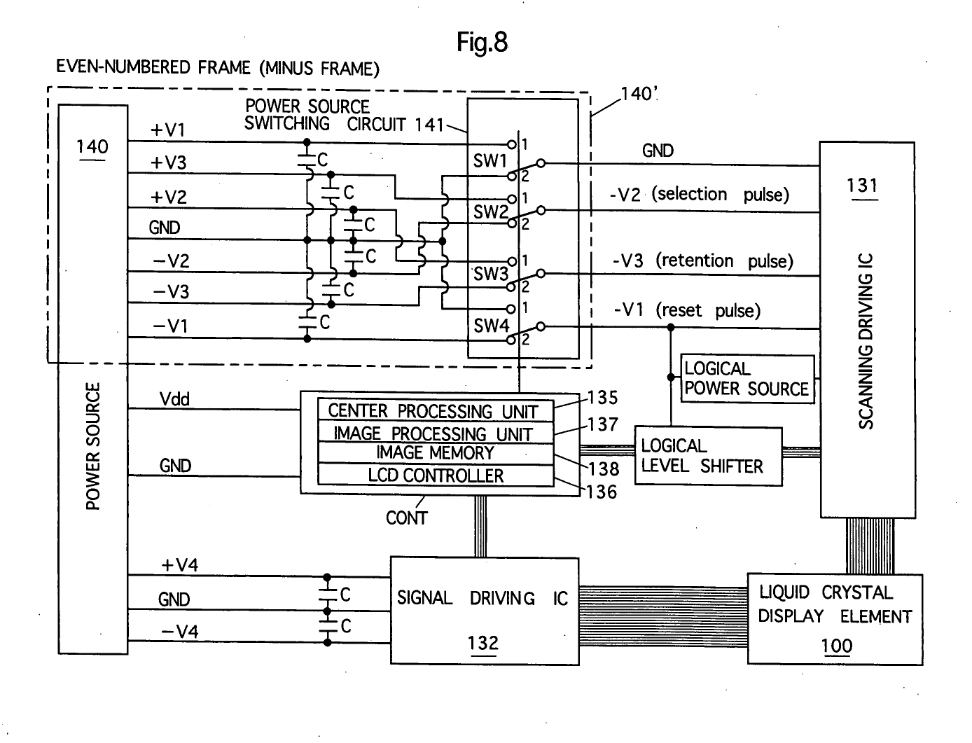

FIGS. 7 and 8 show another example of structure of the driving circuit. In the structure of the circuit shown in FIGS. 7 and 8, a power source switching circuit 141 is provided between the power source 140 and the scanning driving IC in the circuit structure shown in FIG. 3.

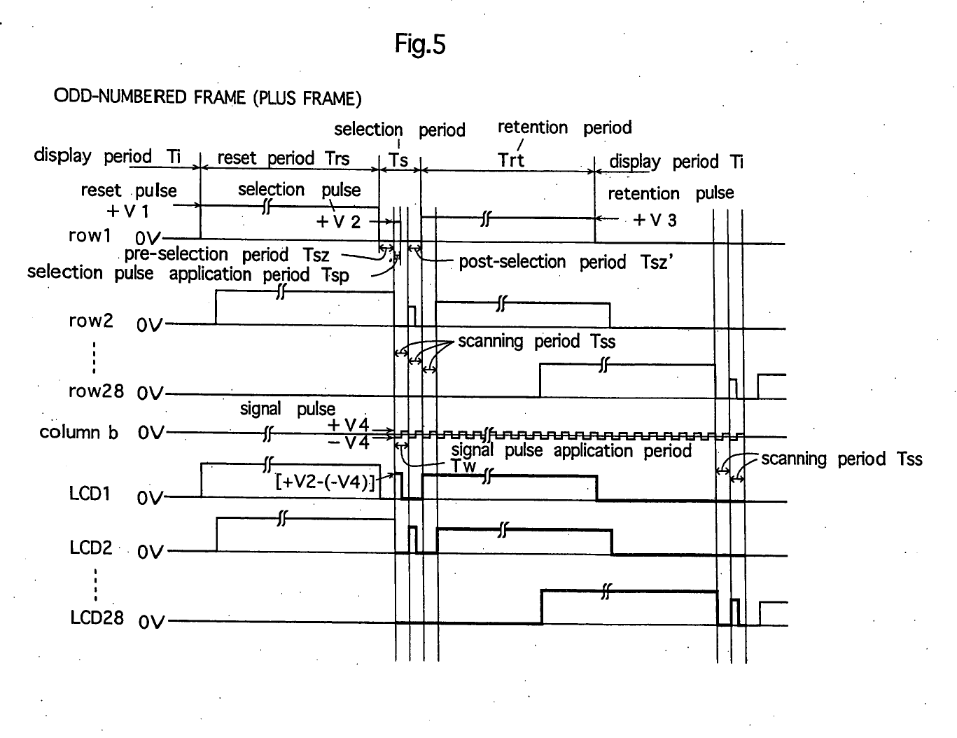

In the structure of the circuit shown in FIGS. 4 and 5, the power source 140 and the power source switching circuit 141 constitutes a power source 140′ which can switch positive and negative of output voltage. The power source 140′ is connected to the controller CONT and has 4 switching elements SW1 to SW4.

The elements SW1 to SW4 can be simultaneously switched under directions from the controller CONT to a state of applying a positive driving voltage (side 1 in the drawing) or to a state of applying a negative driving voltage (side 2 in the drawing). When the switching elements are in the state of side 1, the power source 140′ can supply positive voltages +V1, +V2, +V3 from the power source 140 to the scanning driving IC 131. On the other hand, when the switching elements are in the state of side 2, the power source 140′ can supply negative voltages −V1, −V2, −V3 from the power source 140 to the scanning driving IC 131.

In the driving circuit having the circuit structure shown in FIGS. 7 and 8, the controller CONT can control the power source 140′ and the scanning driving IC 131 so that the driving voltage to be applied to the scanning electrodes 113 by switching from positive voltages +V1, +V2, +V3 to negative voltages −V1, −V2, −V3 or vice versa is given a single polarity in each frame, and polarity inversion is effected in every frame. According to the driving device, the driving of liquid crystal display element can be realized by a simple circuit structure. FIG. 7 shows the state of odd-numbered frames (plus frames) in which the switching elements SW1 to SW4 are switched to the side 1. FIG. 8 shows the state of even-numbered frames (minus frames) in which the elements SW1 to SW4 are switched to the side 2.

An image can be rewritten usually by successively selecting all scanning lines. When an image is partially rewritten, specific scanning lines alone are successively selected in a way to include a part to be rewritten. Thereby only the required part can be rewritten in a short time. In the circuit structure shown in FIGS. 7 and 8, the voltages to be supplied to the scanning driving IC is ½ the voltages in the structure in FIG. 3. Consequently the scanning driving IC which is inexpensive and which is relatively low in voltage resistance as compared with the structure of FIG. 3 can be used.

(Driving Principle and an Example of Basic Driving, See FIGS. 4 to 6 and FIGS. 9 to 11)

The basic principle of the method of driving the liquid crystal display element 100 is first described. Hereinafter, this matter is explained with reference to specific example using pulse waveforms. However, the driving method is not limited to these waveforms.

FIG. 4(A) shows an example of basic driving waveform in odd-numbered frame (plus frame) which is output from the scanning driving IC 131 to each scanning electrode, and FIG. 4(B) shows an example of basic driving waveform in even-numbered frame (minus frame) which is output from the scanning driving IC 131 to each scanning electrode.

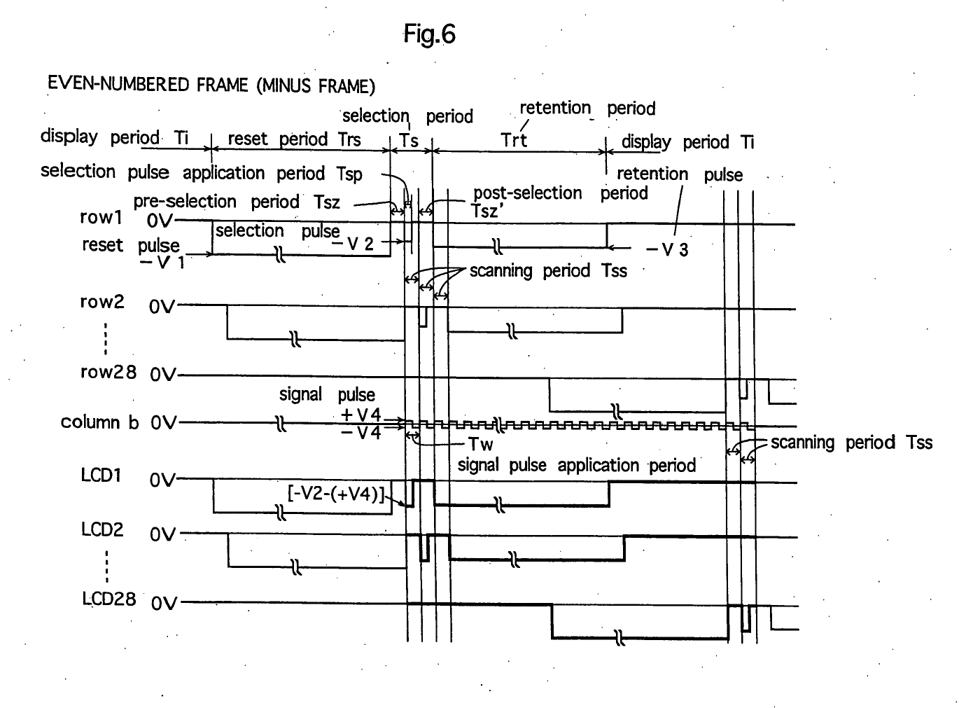

FIGS. 5 and 6 show waveforms of voltages which are output from the scanning driving IC 131 to each scanning electrode 113 (row electrode), a waveform of voltage which is output from the signal driving IC 132 to one signal electrode (column electrode), and waveforms of voltages as applied to the liquid crystals (indicated as LCD 1 to LCD 28 in the drawing) corresponding to pixels by these voltages. FIG. 5 shows waveforms of voltages in odd-numbered frame, and FIG. 6 shows waveforms of voltages in even-numbered frame.

FIGS. 5 and 6 indicate an example of basic driving in which a selection pulse voltage (selection signal voltage) is successively output to the plurality of scanning electrodes 113 (illustrated as 28 row electrodes 1, 2-28 in the drawings) and a signal pulse (rewriting signal voltage) is output from one signal electrode (depicted as a column b in the drawings, the “b” being a natural number satisfying b-n) which is one of the plurality of signal electrodes 114 (a plurality of column electrodes).

The waveform of signal pulse output from the column b shown in the drawings is a waveform capable of successively outputting a pulse which selects the selective reflective state of the liquid crystal in any of scanning periods Tss. It is possible to output any of a waveform of signal pulse selecting a transparent state, a waveform of signal pulse selecting a selective reflective state and a waveform of signal pulse selecting a mixed state (mixture of these states) from the column b. This matter will be described in more detail later.

Indicated at LCD 1, 2 to 28 in the drawings are liquid crystals corresponding to the pixels intersectionally formed between the scanning electrodes (rows 1, 2-28) and the signal electrode (column b), and are waveforms of voltages applied to the liquid crystals corresponding to the pixels. A cross-talk pulse due to the signal pulse applied to the signal electrode is applied to the liquid crystals. FIGS. 5 and 6 indicate, in thick lines, ranges to which the cross-talk pulse is applied. This matter will be explained in detail later.

In this driving, as described above, the driving voltage to be applied to the scanning electrodes (rows 1, 2 to 28) in scanning is given a single polarity in each frame and the polarity is reversed in every frame. For example, the driving voltage is given a single polarity in scanning in one frame, namely until the scanning operation in one frame is completed, using the first scanning electrode (row 1) to the last scanning electrode (row 28). Then the polarity of the driving voltage is reversed for scanning in next one frame.

A driving period is roughly divided into a reset period Trs, a selection period Ts, a retention period Trt and a display period Ti. The selection period Ts is subdivided into a scanning period Tss, a pre-selection period Tsz and a post-selection period Tsz′.

These periods are adjusted to decrease with increase in temperature, and thus to increase with decrease in temperature for compensating lowering of response due to the temperature of liquid crystal. This adjustment changes a width (length) of each pulse. The above adjustment is performed based on the temperature information obtained by the temperature sensor 150 and provided to the central processing unit 135.

In the example illustrated in the figures, Tsz is equal to Tsz′, and therefore, the scanning period Tss is a period of {Ts−(Tsz+Tsz′)} which is present at a midrange of the selection period Ts. Assuming that a relationship of Tss=Tsz=Tsz′ is satisfied, the selection pulse application period Tsp occupies one-sixth of the selection period Ts because Tss is equal to (2×Tsp) as already described. The drive with Tsp/Ts=⅙ will be referred to as “⅙ drive”.

Tsp/Ts is not restricted to ⅙. For compensating variations in response due to the temperature of the liquid crystal, Tsp/Ts equal to, e.g., ½ (½ drive) may be employed when the temperature of or around the liquid crystal display element rises from a predetermined temperature range, and Tsp/Ts equal to, e.g., 1/10 (1/10 drive) may be employed when the temperature of or around the liquid crystal display element lowers below the predetermined temperature range.

In any one of the foregoing cases, the selection period Ts is a period from the end of the reset period Trs to the start of the retention period Trt. A time Ts (ms), which is equal to the selection period Ts in this example, from the end of the reset period Trs to the start of the retention period Trt is determined such that the time Ts and a period Tlc (ms) required for transition of the liquid crystal from the homeotropic state to the spiral structure state may satisfy a relationship (1) of (0.4≦Ts/Tlc≦1.0).

For determining the time Ts (ms), it is necessary to predetermine the period Tlc (ms) required for transition of the liquid crystal 116, which is used in this example, from the homeotropic state to the spiral structure state. The manner of determining the period Tlc (ms) will be described later.

As illustrated in FIGS. 4 to 6, in basic driving waveforms, a reset pulse (positive pulse +V1 in odd-numbered frames and negative pulse −V1 in even-numbered frames) is applied in the reset period Trs. In the selection period Ts, a selection pulse (positive pulse +V2 in odd-numbered frames and negative pulse −V2 in even-numbered frames) is applied in the selection pulse application period Tsp. In the scanning period Tss including the period Tsp, a signal pulse +V4 is applied from the signal driving IC 132. The signal pulse +V4 is determined based on the image data. As described above, the signal pulse +V4 is a rectangular pulse which has a duty ratio of 50% and in which the absolute values of positive and negative voltages (+V4, −V4) are identical with each other. In the basic driving waveform, the voltage is zero in the pre-selection period Tsz and the post-selection period Tsz′. Further, a retention pulse (positive pulse +V3 in odd-numbered frames, and negative pulse −V3 in even-numbered frames) is applied in the retention period Trt.

The liquid crystal operates as follows. First, when the reset pulse of +V1 (odd-numbered frames) or −V1 (even-numbered frames) is applied in the reset period Trs, the liquid crystal is reset to a homeotropic state. The reset period Trs proceeds to the selection pulse application period Tsp via the pre-selection period Tsz (during which the liquid crystal becomes slightly retwisted). The waveform of the pulse to be applied to the liquid crystal in the period Tsp is varied with a pixel finally selecting a planar state, with a pixel finally selecting a focal conic state or with a pixel finally selecting a mixed state in which the planar and focal conic states are mixed.

FIGS. 4 to 6 show cases of selecting a planar state. When a focal conic state is to be selected, the phase of the signal pulse is shifted to an extent corresponding to a half-period compared with the case of selecting a planar state.

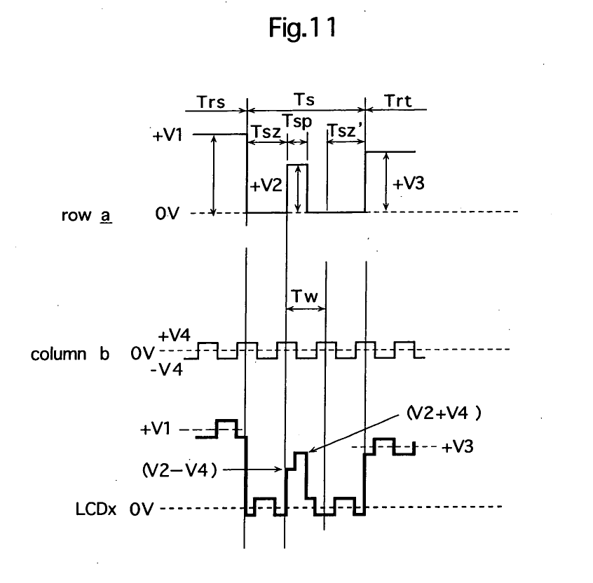

For selecting the state (halftone state), in which the above states are mixed, the phase of the signal pulse may be shifted by a magnitude shorter or longer than half the cycle. For example, the phase may be shifted by a quarter of the cycle (see FIG. 11).

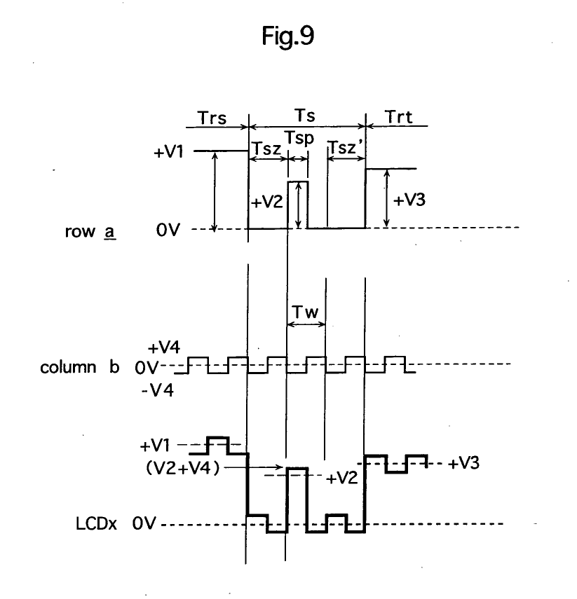

The case of selecting a planar state will be described. In this case, in the selection pulse application period Tsp, a voltage of [(+V2)−(−V4)] in odd-numbered frames (see FIGS. 5 and 9), or a voltage of [(−V2)−(+V4)] in even-numbered frames(see FIG. 6) is applied to the liquid crystal to bring the liquid crystal to a homeotropic state again. Thereafter the liquid crystal becomes slightly retwisted in the post-selection period Tsz′. Then when the retention pulse of +V3 (odd-numbered frames) or −V3 (even-numbered frames) is applied in the retention period Trt, the liquid crystal having become slightly retwisted in the post-selection period Tsz′ becomes further loose by application of the retention pulse and is brought to a homeotropic state.

In FIGS. 9 to 11, LCDx represents liquid crystal, which is supplied with both the waveforms of the selection pulse provided to the row a and the signal pulse provided to the column b.

The liquid crystal in the homeotroic state is brought to a planar state by change-over to voltage zero and is fixed in the planar state.

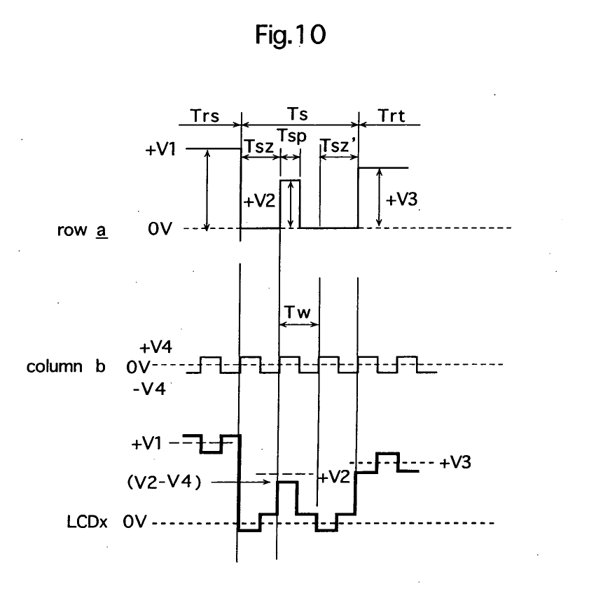

On the other hand, when a focal conic state is finally selected, a voltage of [(+V2)−(+V4)] in odd-numbered frames (see FIG. 10) or a voltage of [(−V2)−(−V4)] in even-numbered frames is applied in the selection pulse application period Tsp. In post-selection period Tsz′, the liquid crystal becomes retwisted and a state having a helical pitch spreading approximately twice.

Subsequently, the retention pulse of +V3 (odd-numbered frames) or −V3 (even-numbered frames) is applied in the retention period Trt. The liquid crystal having become slightly retwisted in the post-selection period Tsz′ is brought to a focal conic state by application of the retention pulse. The liquid crystal in the focal conic state is fixed in the focal conic state even by change-over to voltage zero.

For selecting the halftone state, the phase of the signal pulse is shifted, e.g., by ¼ of the cycle, in which case the odd-numbered frames are processed as follows. As illustrated in FIG. 11, {(+V2)−(+V4)} is applied during a half of the selection pulse application period Tsp, and {(+V2)−(−V4)} is applied during the following half of the period Tsp. For the even-numbered frames, {(−V2)−(−V4)} is applied during a half of the period Tsp, and {(−V2)−(+V4)} is applied during the following half of the period Tsp.

According to the above-described method and device for driving the liquid crystal display element and liquid crystal display apparatus, when the scanning operation is performed in each frame for matrix driving of the liquid crystal display element 100, the driving voltage to be applied to the scanning electrodes 113 is given a single polarity in each frame and the polarity is reversed in every frame, whereby the state of single polarity of the voltage to be applied to the liquid crystal 116 in each frame can continuously last for a prolonged period of time.

Consequently compared with use of, for example, an alternating voltage whose polarity of voltage waveform is periodically changed as a voltage to be applied to the liquid crystal 116, it is possible to reduce a waveform repeating frequency of voltage to be applied to the liquid crystal 116, and the value of driving voltage to be applied to the scanning electrode 113 can be decreased by ½, thereby correspondingly lowering the consumption of power for driving the liquid crystal display element 100. Namely the liquid crystal display element 100 can be driven by reduced power consumption.

As indicated with thick lines in FIGS. 5 and 6, any of the waveforms of the voltages to be applied to the liquid crystals LCD1, LCD2 . . . LCD28 suffers a cross-talk due to the signal pulse to be applied to the signal electrode.

As described above, if the selection pulse voltage to be applied to the row a is a voltage whose application period Tsp is ½ the scanning period Tss and the signal pulse voltage to be applied to the column b has a rectangular pulse waveform which has a duty ratio of 50% and in which the absolute values of positive and negative voltages are identical with each other, voltages applied to the liquid crystals LCD 1, LCD 2 to LCD 28 corresponding to pixels due to the cross-talk can be made substantially constant, whereby a shadowing occurring in image display due to the cross-talk can be suppressed.

The time Ts (ms), which is equal to the selection period Ts in this example, from the end of the reset period Trs to the start of the retention period Trt is determined such that the time Ts and the period Tlc (ms) required for transition of the liquid crystal 116 from the homeotropic state to the spiral structure state may satisfy the relationship (1) of (0.4≦Ts/Tlc≦1.0). Therefore, appropriate contrast and an appropriate gamma curve can be achieved, and good display can be performed. This will be described later.

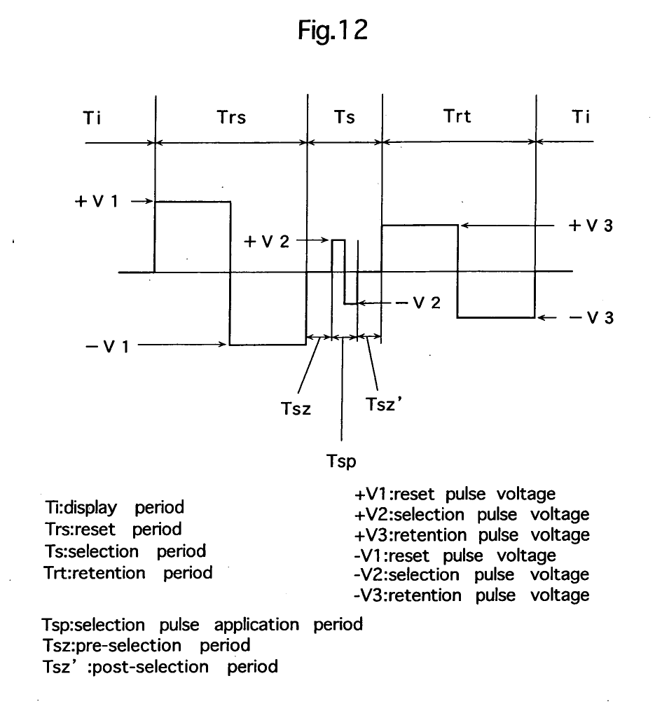

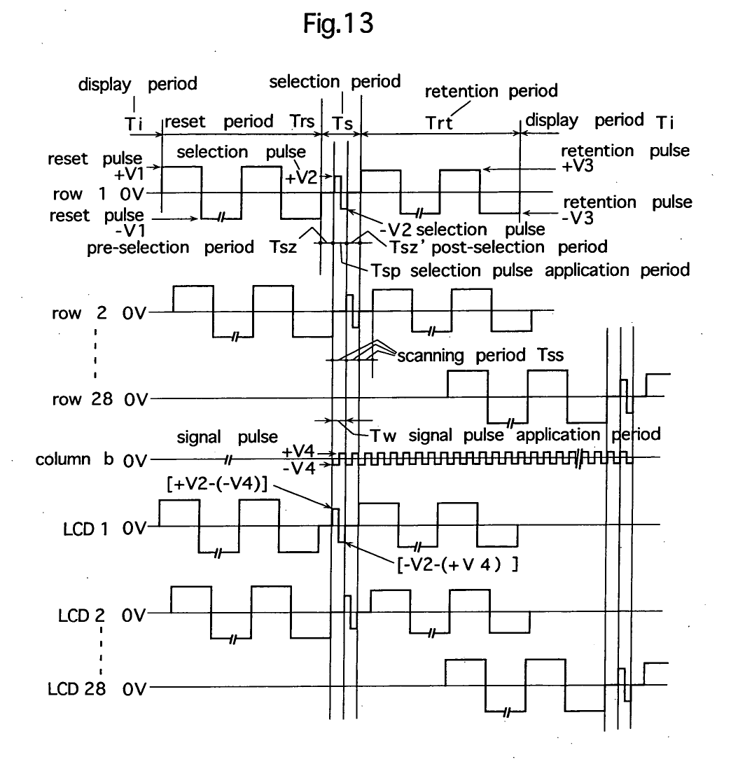

The voltage applied to the scanning electrodes may not be inverted between the plus and minus in each frame, and an alternating voltage may be applied in each frame. FIG. 12 illustrates, by way of example, a basic driving waveform for applying an alternating voltage from the scanning drive IC to each scanning electrode. FIG. 13 illustrates, by way of example, waveforms of voltages supplied from the scanning driving IC to the scanning electrodes (row electrodes), a waveform of a voltage supplied from the signal driving IC to a part of signal electrodes (column electrodes) and waveforms of voltages applied, as a result of application of the above voltages, to portions (indicated by LCD1-LCD28 in FIG. 13) of the liquid crystal display 116 corresponding to the respective pixels.

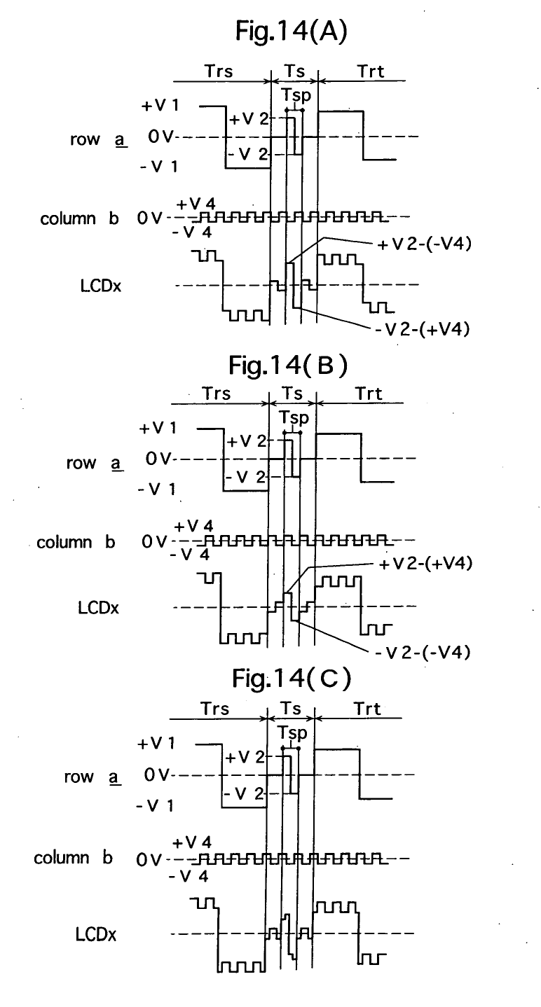

FIG. 14(A) illustrates waveforms of applied voltages, which set the liquid crystal display LCDx of the pixel to the planar state. FIG. 14(B) illustrates waveforms of applied voltages, which set the liquid crystal display LCDx of the pixel to the focal conic state. FIG. 14(C) illustrates waveforms of applied voltages, which achieve halftone display by the liquid crystal display LCDx.

(Method of Determining Period Tlc)

Description will now be given on a method of determining the period Tlc (ms) required for transition of the liquid crystal 116 in the liquid crystal display element 100 from the homeotropic state to the spiral structure state. In the following example, the liquid crystal display element employs two kinds of chiral nematic liquid crystal L1 and L2.

Liquid Crystal L1:

Chiral nematic liquid crystal containing 77.0 wt % of nematic liquid crystal (MLC6436-000 manufactured by Merk & Co) and 23.0 wt % of chiral material (S-811 manufactured by Merk & Co.) added thereto.

Liquid Crystal L2:

Chiral nematic liquid crystal containing 80.5 wt % of nematic liquid crystal (BL006 manufactured by Merk & Co), 14.1 wt % of chiral material (CB15 manufactured by Merk & Co.) and 5.4 wt % of chiral material (R1011 manufactured by Merk & Co.).

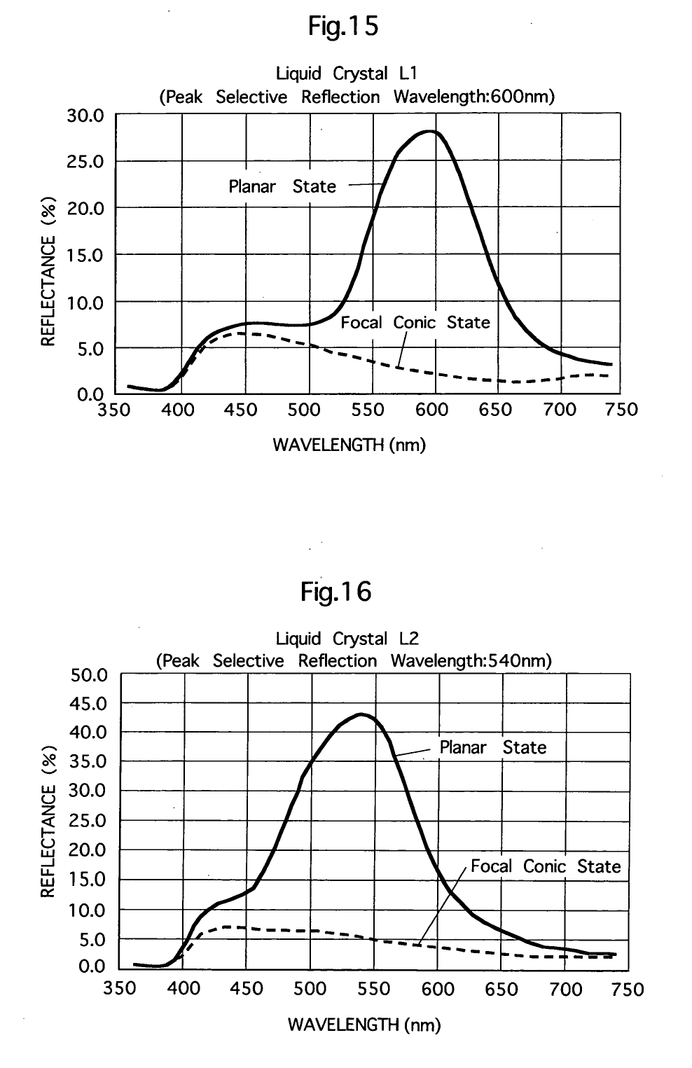

The liquid crystal L1 in the planar state has the selective reflection peak wavelength of about 600 nm, and exhibits yellow, as illustrated in FIG. 15.

The liquid crystal L2 in the planar state has the selective reflection peak wavelength of about 540 nm, and exhibits green, as illustrated in FIG. 16.

Two kinds of liquid crystal display elements were prepared by using liquid crystal L1 and liquid crystal L2, respectively.

These liquid crystal display elements had the same basic structures as that of the liquid crystal display element 100 in FIG. 1, and employed the substrates and others described below.

Each substrate: transparent glass substrate of 0.7 mm in thickness

Transparent electrodes on each substrate: electrodes made of ITO film and having film resistance of 10 ohm/square(Ω/□)

An orientation film of 800 Å in thickness made of soluble polyimide (AL-8044 manufactured by JSR Corp.) was formed by printing on the electrodes of each substrate.

Sealing material: made of SUMILIGHT ERS-2400 (main material) and hardening agent ERS-2840 both manufactured by Sumitomo Bakelite Co., Ltd.

Spacer: Micropearl of 5.5 μm in grain diameter manufactured by Sekisui Finechemical Co., Ltd.

The liquid crystal L1 (or L2) was held together with the spacers between the paired glass substrates provided with the transparent electrodes and the orientation films, and the sealing materials were applied to peripheries of the substrates. In this manner, an element A1 having the liquid crystal L1 and an element A2 having the liquid crystal L2 were prepared.

(1) Element A1 Having liquid crystal L1

A reset pulse (voltage value Vrs=40 V, reset period Trs=50 ms) enough to reset the liquid crystal L1 to the homeotropic state was applied to the element A1. After a period Tint (ms), a retention pulse (voltage value Vrt, retention period. Trt=24 ms) was applied to the element A1.

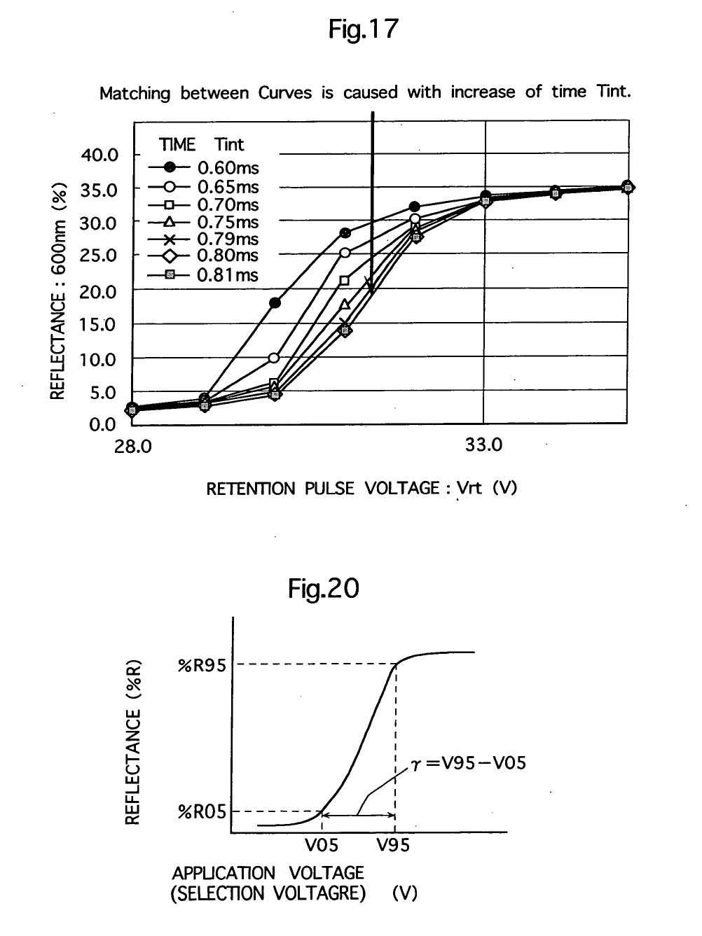

The period Tint was changed in a range from 0.6 ms to 0.81 ms, the voltage value Vrt of the retention pulse was changed in a range from 28 V to 35 V for each of the values of the period Tint thus changed. For each of the voltage values changed while keeping each period value, the reflectance was measured at the peak selective reflection wavelength of 600 nm of the element A1 after the end of application of the retention pulse. The reflectance was measured with a spectrocolorimeter CM-3700d manufactured by Minolta Co., Ltd. Results of this measurement are illustrated in the following Table 1 and FIG. 17.

TABLE 1

| Retention Pulse | Time Tint | | | | | | |
|---|---|---|---|---|---|---|---|
| Voltage: Vrt | 0.6 ms | 0.65 ms | 0.7 ms | 0.75 ms | 0.79 ms | 0.8 ms | 0.81 ms |
| 28 V | 2.623 | 2.486 | 2.421 | 2.399 | 2.362 | 2.374 | 2.374 |
| 29 V | 3.772 | 3.234 | 3.02 | 2.9 | 2.836 | 2.826 | 2.826 |
| 30 V | 17.983 | 9.764 | 6.171 | 4.859 | 4.451 | 4.312 | 4.312 |
| 31 V | 28.44 | 25.18 | 21.724 | 17.892 | 14.874 | 13.781 | 13.781 |
| 32 V | 31.983 | 30.262 | 28.845 | 28.057 | 27.589 | 27.301 | 27.301 |
| 33 V | 33.572 | 32.927 | 32.806 | 33.059 | 33.171 | 33.158 | 33.158 |
| 34 V | 34.369 | 34.091 | 34.039 | 34.027 | 33.975 | 33.917 | 33.917 |
| 35 V | 34.809 | 34.676 | 34.574 | 34.487 | 34.422 | 34.374 | 34.374 |

In FIG. 17, it was determined that the period Tlc is equal to the shortest value among those of the time Tint (ms), which substantially cause matching between a plurality of character curves representing changes in reflectance with respect to the retention pulse for the respective values of the period Tint. Thus, it was determined that the period Tlc of the liquid crystal L1 of the element A1 illustrated in FIG. 17 is equal to 0.8 ms.

(2) Liquid Crystal Display Element A2 Having Liquid Crystal L2

Measurements were performed similarly to the liquid crystal L1, and the period Tlc of the liquid crystal L2 of the element A2 was determined to be equal to 1.6 ms (Tlc=1.6 ms).

As can be understood from the above, the period Tlc can be determined by executing:

a data obtaining step of repeating a step of applying the reset pulse enough to reset the liquid crystal to the homeotropic state and applying the retention pulse after elapsing of the time Tint (ms) from the end of the application of the reset pulse, and a step of measuring the reflectance of the liquid crystal display element at the peak selective reflection wavelength after the end of application of the retention pulse, while changing the value of the time Tint (ms) and changing the retention pulse with respect to each of the values of the time Tint (ms),

a characteristic curve producing step of producing the characteristic curves representing variations in reflectance of the liquid crystal display element at the peak selective reflection wavelength corresponding to the voltage values of the retention pulse with respect to each of the values of the time Tint (ms) obtained in the data obtaining step, and

a step of determining, as the value of the period Tlc (ms), the smallest time value of the time Tint (ms) among the values substantially causing matching between the plurality of characteristic curves in the characteristic curve group obtained in the characteristic curve producing step.

Description will now be given on a reason, for which the period Ts (ms) from the end of the reset period to the start of the retention period is determined to satisfy the relationship (1) of (0.4≦Ts/Tlc≦1.0).

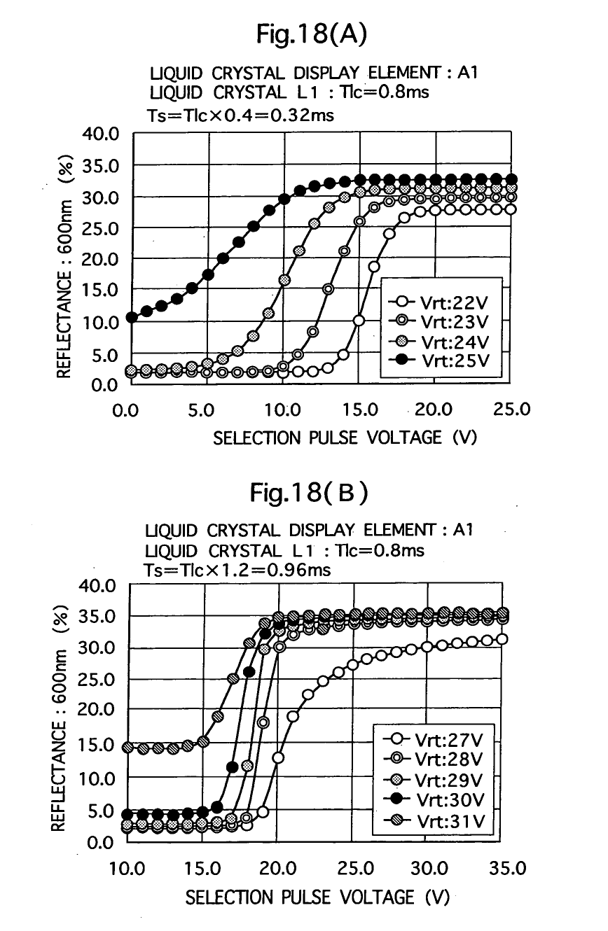

For the liquid crystal display element A1, the selection period Ts was set to 0.32 ms {Tlc (=0.8 ms)×0.4}, and was also set to 0.96 ms {Tlc (=0.8 ms)×1.2}. In the case of Ts=0.32 ms, the voltage value Vrt of the retention pulse was changed by 1 volt between 22 V to 25 V. In the case of Ts=0.96 ms, the voltage value Vrt of the retention pulse was changed by 1 volt between 27 V to 31 V. In these cases, the ⅙ driving already described was performed to apply the selection voltage of various voltage values, and the variations in reflectance at the peak selective reflection wavelength of the element A1 were measured after each application of the retention pulse. Results of the measurement are illustrated in FIGS. 18(A) and 18(B). FIGS. 18(A) and 18(B) illustrate character curves (gamma curves), which represent variations in reflectance of the element A1 at the peak selective reflection wavelength of the liquid crystal L1 with respect to the selection voltage, and particularly illustrate the character curves corresponding to respective values of the retention pulse.

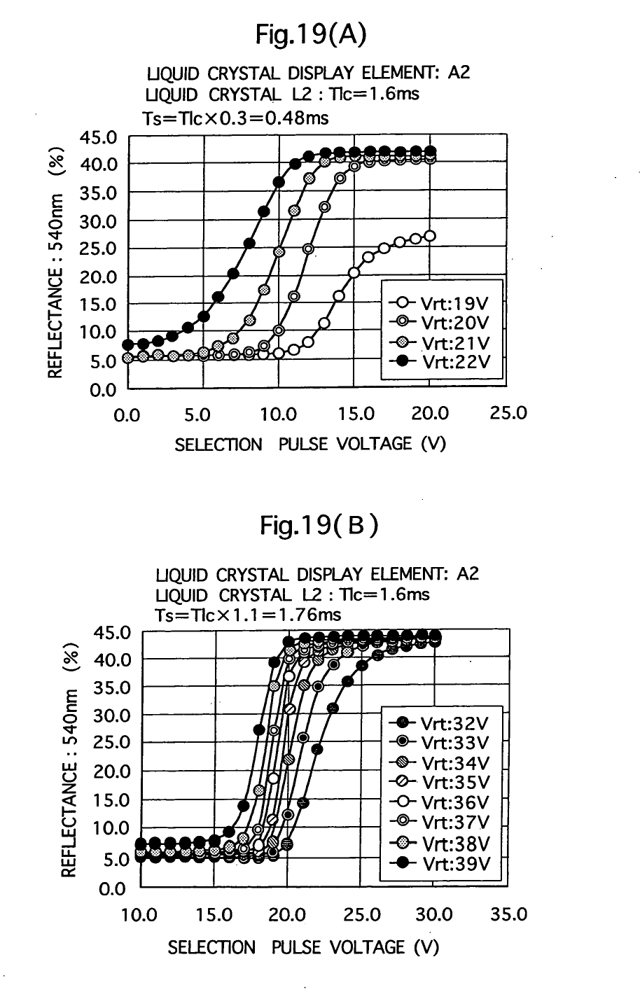

For the liquid crystal display element A2, the selection period Ts was set to 0.48 ms {Tlc (=1.6 ms)×0.3}, and was also set to 1.76 ms {Tlc (=1.6 ms)×1.1}. In the case of Ts=0.48 ms, the voltage value Vrt of the retention pulse was changed by 1 volt between 19 V to 22 V. In the case of Ts=1.76 ms, the voltage value Vrt of the retention pulse was changed by 1 volt between 32 V to 39 V. In these cases, the ⅙ driving already described was performed to apply the selection voltage of various voltage values, and the variations in reflectance at the peak selective reflection wavelength of the element A2 were measured after each application of the retention pulse. Results of the measurement are illustrated in FIGS. 19(A) and 19(B). FIGS. 19(A) and 19(B) illustrate character curves (gamma curves), which represent variations in reflectance of the element A2 at the peak selective reflection wavelength of the liquid crystal L2 with respect to the selection voltage, and particularly illustrate the character curves corresponding to respective values of the retention pulse.

In any one of the foregoing measurements relating to the elements A1 and A2, the voltage value Vrs of the reset pulse was equal to 40 V, and the reset period Trs thereof was equal to 50 ms. Also, the application period (retention period Trt) of the retention pulse was equal to 24 ms.

The reflectance was measured with the spectrocolorimeter CM-3700d manufactured by Minolta Co., Ltd.

Description will now be given on the gamma curve representing the variations in reflectance of the liquid crystal display element at the peak selective reflection wavelength of the liquid crystal with respect to the selection voltage. FIG. 20 illustrates an example of the gamma curve. In the gamma curve, gamma represents a difference between voltage values V95 and V05 of the selection voltage, where the voltage value V95 provides a reflectance of 95% of saturated reflectance of the liquid crystal (i.e., (% R95)), and the voltage value V05 provides a reflectance of 5% of the saturated reflectance of the liquid crystal (i.e., (% R05)).

In the liquid crystal display element, if the gamma curve is excessively gentle (flat), the selection voltage value not extending over an excessive range cannot achieve the sufficient planar state (sufficient reflective state of the liquid crystal display element) and the sufficient focal conic state (sufficient transparent state of the display element) without difficulty, and thus cannot achieve good contrast without difficulty. If the gamma curve is excessively steep, it is difficult to deal with the environmental variations (primarily, variations in environment temperature) and the changes of the liquid crystal display element with time, and good display cannot be performed without difficulty.

If the gamma curve is excessively gentle, gamma takes a excessively large value. If the gamma curve is excessively steep, gamma takes an excessively small value. In view of the case where the liquid crystal display element employs an ordinary scanning driving IC and an ordinary signal driving IC, therefore, it is preferable that gamma is in a range from about 5 to about 8.

FIGS. 18(A) and 19(A) illustrate the following tendency. If the ratio Ts/Tlc between the period (selection period) Ts (ms) from the end of the reset period to the start of the retention period and the time Tlc (ms) required for transition of the liquid crystal from the homeotropic state to the spiral structure state is excessively small, the gamma curve becomes excessively gentle (gamma becomes excessively large) so that sufficient contrast cannot be achieved without difficulty. FIGS. 18(B) and 19(B) illustrate the following tendency. If the ratio Ts/Tlc is excessively large, the gamma curve becomes excessively steep (gamma becomes excessively small) so that it is difficult to deal with the temperature variations and changes with time. As can be seen therefrom, the ratio Ts/Tlc is a factor allowing good display.

Experiments were performed for determining a range of the ratio Ts/Tlc achieving good display with gamma from five to eight. The experiments will now be described.

As illustrated in the following Table 2, the liquid crystal of the display element A1 had Tlc equal to 0.8 ms. The voltage value of the reset pulse was 40 V, and the reset period Trs was equal to 50 ms. The application period (retention period Trt) of the retention pulse was equal to 24 ms. The selection period Ts was changed to various values, and the retention pulse voltage value Vrt for each value of the selection period Ts was changed to various values. Under these conditions, the gamma curve was obtained similarly to that in FIG. 20, and gamma corresponding to each combination of the selection period Ts and the retention pulse voltage value was obtained from the gamma curve thus obtained.

As illustrated in the following Table 3, the gamma curve was obtained from the display element A2 employing the liquid crystal of Tlc equal to 1.6 ms, similarly to the experiment performed on the element A1. From the gamma curve thus obtained, the gamma was obtained in connection with each combination of the selection period Ts and the retention pulse voltage value Vrt.

TABLE 2
Liquid Crystal Display Element: A 1
Liquid Crystal L 1: Tlc = 0.8 ms

| Selection | | | | | | | |
|---|---|---|---|---|---|---|---|
| Period: | Retention Pulse Voltage: Vrt (Volt) | | | | | | |
| Ts (ms) | 23 | 24 | 25 | 26 | 27 | 28 | 29 |

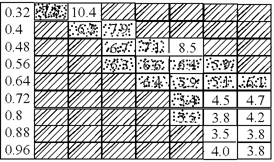

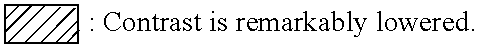

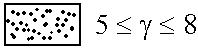

TABLE 3
Liquid Crystal Display Element: A 2
Liquid Crystal L2: Tlc = 1.6 ms

| Selection | | | | | | | | | | | | | | | | | | |
|---|---|---|---|---|---|---|---|---|---|---|---|---|---|---|---|---|---|---|
| Period: | Retention Pulse Voltage: Vrt (Volt) | | | | | | | | | | | | | | | | | |
| Ts (ms) | 20 | 21 | 22 | 23 | 24 | 25 | 26 | 27 | 28 | 29 | 30 | 31 | 32 | 33 | 34 | 35 | 36 | 37 |

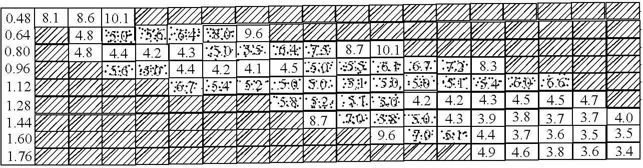

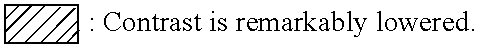

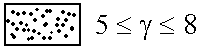

In the Tables 2 and 3, hatched portions represent combinations of the selection period Ts and the voltage value of the retention pulse, which remarkably lowered the contrast. Shaded portions represent combinations of the selection period Ts and the voltage value of the retention pulse, which provided gamma in a range from five to eight. In the Table 2, the range of gamma from five to eight can be achieved by a range of Ts satisfying (0.32≦Ts≦0.80) and a range of the ratio Ts/Tlc satisfying (0.4≦Ts/Tlc≦1.0). In the Table 3, the range of gamma from five to eight can be achieved by a range of Ts satisfying (0.64≦Ts≦1.60) and a range of the ratio Ts/Tlc satisfying (0.4≦Ts/Tlc≦1.0), which is the same as that in the Table 2.

From the results of experiments described above, it can be understood that the ratio Ts/Tlc in the range from 0.4 to 1.0 can provide the gamma taking a value from five to eight, and can achieve good display.

In the liquid crystal display element A, the ratio Ts/Tlc satisfying (0.4≦Ts/Tlc≦1.0) in the image drawing processing can appropriately provide the contrast and the gamma curve for display by the liquid crystal display element 100 so that the liquid crystal display apparatus performing the image display can achieve good contrast as a whole, and can suppress the influences by the environmental variations (primarily, in environment temperature) and the changes of the element with time.

From the Tables 2 and 3, it is more preferable that the ratio of Ts/Tlc satisfies the relationship (2) of (0.5≦Ts/Tlc≦0.9). By satisfying this relationship (2), the liquid crystal display element 100 can exhibit the appropriate contrast and gamma curve more reliably so that the liquid crystal display apparatus A can perform good image display more reliably.

In the liquid crystal display apparatus A, the temperature sensor 150 provides the detected temperature information to the central processing unit 135 for compensating variations in response due to the temperature variations of the liquid crystal. The driving circuit adjusts the length of the periods such as the selection period Ts based on the temperature information. This adjustment is performed to satisfy the relationship (1) of (0.4≦Ts/Tlc≦1.0), and more preferably to satisfy the relationship (2) of (0.5≦Ts/Tlc≦0.9).

This adjustment can be performed as follows. The time Tlc of the liquid crystal was measured in advance with various values of the temperature, and the measured values were stored in the ROM of the central processing unit 135. In the central processing unit 135, the value of Tlc corresponding to the temperature detected by the sensor 150 was selected from the plurality of values of Tlc, and calculation is performed to determine the selection period Ts satisfying the relationship (1) of (0.4≦Ts/Tlc≦1.0), and more preferably the relationship (2) of (0.5≦Ts/Tlc≦0.9).

Alternatively, the following manner may be employed. A temperature table is prepared and stored in the ROM of the central processing unit 135. This temperature table represents the selection period Ts satisfying the relationship (1) of (0.4≦Ts/Tlc≦1.0), and more preferably the relationship (2) of (0.5≦Ts/Tlc≦0.9) with various values of the temperature. The value of Tlc corresponding to the temperature detected by the sensor 150 is selected from the plurality of values of Tlc stored in the central processing unit 135. Based on the selected Tlc, the selection period Ts satisfying the relationship (1) and, more preferably, the relationship (2) is determined from the temperature table.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method of driving a liquid crystal display element having a memory property and performing display by utilizing selective reflection of a cholesteric liquid crystal phase, wherein
a driving voltage of a waveform including a reset period for resetting liquid crystal included in said liquid crystal display element to a homeotropic state, a selection period for selecting arrangement of molecules of the liquid crystal in a voltage-free state and a retention period for ensuring a final display state of said liquid crystal is applied to said liquid crystal for drawing an image, and a time Ts (ms) from end of said reset period to start of said retention period and a period Tlc (ms) required for transition of said liquid crystal from the homeotropic state to a spiral structure state provide a ratio of Ts/Tlc satisfying a relationship (1) of (0.4≦Ts/Tlc≦1.0) when drawing the image.

2. A method of driving the liquid crystal display element according to claim 1, wherein
said ratio Ts/Tlc is determined to satisfy a relationship (2) of (0.5≦Ts/Tlc≦0.9).

3. A method of driving the liquid crystal display element according to claim 1, wherein
halftone display is achieved by modulating at least one of a width and a voltage value of a pulse applied to said liquid crystal during said selection period.

4. A method of driving the liquid crystal display element according to claim 1, wherein
said time Ts is changed according to a temperature of said liquid crystal display element or a neighboring portion to provide said ratio of Ts/Tlc satisfying said relationship (1).

5. A method of driving the liquid crystal display element according to claim 1, wherein
polarity of the voltage applied to said liquid crystal is inverted in every frame.

6. A method of driving the liquid crystal display element according to claim 1, wherein
the voltage applied to said liquid crystal is an AC voltage.

7. A liquid crystal display apparatus comprising a liquid crystal display element having a memory property and performing display by utilizing selective reflection of a cholesteric liquid crystal phase, and a driving circuit for driving said liquid crystal display element, wherein
a driving voltage of a waveform including a reset period for resetting liquid crystal included in said liquid crystal display element to a homeotropic state, a selection period for selecting arrangement of molecules of the liquid crystal in a voltage-free state and a retention period for ensuring a final display state of said liquid crystal is applied by the driving circuit to said liquid crystal for drawing an image, and a time Ts (ms) from end of said reset period to start of said retention period and a period Tlc (ms) required for transition of said liquid crystal from the homeotropic state to a spiral structure state provide a ratio of Ts/Tlc satisfying a relationship (1) of (0.4≦Ts/Tlc≦1.0) when drawing the image.

8. A liquid crystal display apparatus according to claim 7, wherein
said driving circuit can perform halftone display by modulating at least one of a width and a voltage value of a pulse applied to said liquid crystal during said selection period.

9. A liquid crystal display apparatus according to claim 7, wherein
said liquid crystal display element includes a plurality of scanning electrodes and a plurality of signal electrodes opposed to said scanning electrodes with a layer of the liquid crystal therebetween, and said driving circuit drives said liquid crystal display element in a simple matrix driving method.

10. A liquid crystal display apparatus according to claim 9, wherein
said driving circuit sets a pulse voltage applied to said signal electrode to be smaller in an absolute value than a threshold causing cross-talk.

11. A liquid crystal display apparatus according to claim 7, further comprising:
a temperature detector, wherein said driving circuit changes said time Ts based on temperature information provided from said temperature detector with respect to said period Tlc at the temperature detected by the detector to satisfy said relationship (1).

12. A liquid crystal display apparatus according to claim 7, wherein
said liquid crystal display element includes chiral nematic liquid crystal prepared by adding a chiral material enough in amount to exhibit the cholesteric liquid crystal phase to a nematic liquid crystal.

13. A liquid crystal display apparatus according to claim 7, wherein
said liquid crystal display element performs mono-color display.

14. A liquid crystal display apparatus according to claim 7, wherein
said liquid crystal display element performs full-color display.

15. A liquid crystal display apparatus according to claim 7, wherein
said driving circuit sets said ratio Ts/Tlc to satisfy further a relationship (2) of (0.5≦Ts/Tlc≦0.9).

16. A liquid crystal display apparatus according to claim 7, wherein
said driving circuit inverts polarity of the voltage applied to said liquid crystal in every frame.

17. A liquid crystal display apparatus according to claim 7, wherein
said driving circuit uses an AC voltage as the voltage applied to said liquid crystal.

18. A method of determining drive conditions of a liquid crystal display element, wherein said liquid crystal display element has a memory property, performs display by utilizing selective reflection of a cholesteric liquid crystal phase, and draws an image by being supplied with a driving voltage of a waveform including a reset period for resetting liquid crystal included in said liquid crystal display element to a homeotropic state, a selection period for selecting arrangement of molecules of the liquid crystal in a voltage-free state and a retention period for ensuring a final display state of said liquid crystal, said method comprising the steps of:
measuring a period Tlc (ms) required for transition of said liquid crystal display from the homeotropic state to a spiral structure state; and
determining a time Ts (ms) from end of said reset period to start of said retention period to satisfy a relationship of (0.4≦Ts/Tlc≦1.0) with respect to said measured period Tlc.

19. A method of determining the drive conditions of the liquid crystal display element according to claim 18, wherein
said period Tlc is determined by executing:
a data obtaining step of repeating a step of applying a reset pulse enough to reset said liquid crystal to the homeotropic state and applying a retention pulse after elapsing of a time Tint (ms) from end of the application of the reset pulse, and a step of measuring a reflectance of said liquid crystal display element at a peak selective reflection wavelength after end of the application of the retention pulse, while changing the value of said time Tint (ms) and changing said retention pulse with respect to each of the values of said time Tint (ms),
a characteristic curve producing step of producing characteristic curves representing variations in reflectance of said liquid crystal display element at the peak selective reflection wavelength corresponding to voltage values of said retention pulse with respect to each of the values of said time Tint (ms) obtained in said data obtaining step, and
a step of determining, as a value of said period Tlc (ms), the smallest time value of said time Tint (ms) among the values substantially causing matching between the plurality of characteristic curves in the characteristic curve group obtained in said characteristic curve producing step.

20. A method of determining the drive conditions of the liquid crystal display element according to claim 19, wherein
said retention pulse applied in said data obtaining step has a voltage value large enough to establish a selected state based on a selection pulse applied during the selection period.
